(19) United States
(12) Patent Application Publication
(10) Pub. No.: US 2006/0080656 A1
(43) Pub. Date: Apr. 13, 2006

(54) Methods and instructions for patch management

(75) Inventors: Nigel Cain, Redmond, WA (US); Anthony Baron, Woodinville, WA (US); Sanjiv Sharma, Bellevue, WA (US); Frank Zakrajsek, Carnation, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 10/962,769

(22) Filed: Oct. 12, 2004

(51) Int. Cl. G06F 9/445

(52) U.S. Cl. 717/174; 434/118

(57) ABSTRACT

In one aspect, a method of instructing users in the implementation of a patch management process is provided. The patch management process relates to the installation of a software patch in a computer system. The method comprises an act of providing instructions that describe the patch management process in a hierarchical manner so that the patch management process is described as comprising a plurality of top-level activities, with each of the plurality of top-level activities being described as comprising at least one sub-action, the instructions describing trigger events that result in transitions between the top-level activities. In another aspect, a method includes following the instructions that describe the patch management process. In another aspect, an assess activity is performed distinct from the installation of any particular patch to assess the computer system to determine the preparedness of the computer system to process future anticipated but unspecified patches

### FIELD OF THE INVENTION

The present invention relates to implementing and instructing users to implement and administer a patch management process for installing one or more software patches in a computer system.

### BACKGROUND OF THE INVENTION

Patch management describes processes involved in identifying and deploying a software update, also referred to as a patch, into a computing environment. For example, interim software patches may become available that overcome security vulnerabilities in a networked computer system. Similarly, improved software releases that update a computer system to facilitate operational efficiency and effectiveness of the computer system may become available. Without timely deployment of new software patches, security vulnerabilities may be exploited, which may lead to loss of revenue from failure of one or more services and/or downtime of the computer system, loss of profits due to cost of repairs, loss or theft of valuable data assets, etc.

To minimize the threat of security vulnerabilities, the latest software updates relevant to a computer system should be obtained and deployed as quickly and efficiently as possible. Despite the importance of administering a responsive patch management system, many information technology (IT) operations (or simply “operations” for short) lack a structured approach to patch management. As a result, operations may not be aware when a new software patch has been released, and releases that IT operations become aware of may be deployed haphazardly or needlessly, adding considerable time during which the computer system may be vulnerable and adding to the downtime of the computer system during which one or more patches are being deployed.

Attempts have been made to provide guidelines to IT organizations on how to effectively administer a patch management process. For example, Patch Management Using Microsoft Systems Management Server 2.0, provided by Microsoft Corporation provides guidance for deploying software patches, service packs, etc.

### SUMMARY OF THE INVENTION

Aspects according to the present invention include presenting instructions for a patch management process that are relatively simple to understand and follow to facilitate implementation and administration of a generally robust and responsive process for deploying software updates on a computer system.

One aspect according to the present invention includes a method of instructing users in the implementation of a patch management process, the patch management process relating to the installation of a software patch in a computer system. The method comprises an act of providing instructions that describe the patch management process in a hierarchical manner so that the patch management process is described as comprising a plurality of top-level activities, with each of the plurality of top-level activities being described as comprising at least one sub-activity, the instructions describing trigger events that result in transitions between the top-level activities.

Another aspect according to the present invention includes a method of implementing a patch management process to install a software patch in a computer system, the method comprising an act of following instructions that describe the patch management process in a hierarchical manner so that the patch management process is described as comprising a plurality of top-level activities, with each of the plurality of top-level activities being described as comprising at least one sub-activity, the instructions describing trigger events that result in transitions between the top-level activities.

Another aspect according to the present invention method of administering a computer system that comprises one or more software packages that are anticipated to receive patches, the patches to be installed on at least one computer device in the computer system, the computer system comprising a plurality of resources that are employed in the installation of the patches, the method comprising an act of, distinct from the installation of any particular patch, assessing the computer system to determine the preparedness of the computer system to process future anticipated but unspecified patches.

Another aspect according to the present invention includes a method of instructing users in the implementation of a protocol for administering patch management in a computer system that comprises one or more software packages that are anticipated to receive patches, the patches to be installed on at least one computer device in the computer system, the computer system comprising a plurality of resources that are employed in the installation of the patches, the method comprising acts of providing instructions that describe procedures for installing the patches, and providing instructions that describe the protocol as including an assessment phase that is distinct from the installation of particular patches, wherein the assessment phase relates to assessing the computer system to determine the preparedness of the computer system to process future anticipated but unspecified patches.

Another aspect according to the present invention includes a method of implementing a protocol for administering patch management in a computer system that comprises one or more software packages that are anticipated to receive patches, the patches to be installed on at least one computer device in the computer system, the computer system comprising a plurality of resources that are employed in the installation of the patches, the method comprising acts of following instructions that describe the installation of the patches, and following instructions that describe the protocol as including an assessment phase that is distinct from the installation of particular patches, wherein the assessment phase relates to assessing the computer system to determine the preparedness of the computer system to process future anticipated but unspecified patches.

### BRIEF DESCRIPTION OF THE DRAWINGS

FIG. 1 illustrates a flow diagram of top-level activities for administering a patch management process, in accordance with one embodiment of the present invention;

FIG. 2 illustrates a flow diagram of top-level activities and lower level sub-activities for administering a patch management process, in accordance with one embodiment of the present invention;

FIG. 3 is a screen shot using Systems Management Server's (SMS) Security Updates Inventory Tool to compare software updates that have been installed against a list of available software updates, in accordance with one embodiment of the present invention;

FIG. 4 is a screen shot using Systems Management Server's (SMS) Security Updates Inventory Tool to compare software updates that have been installed against the contents of the Office Update Database file, in accordance with one embodiment of the present invention;

FIG. 5 illustrates a diagram of a SMS hierarchy to facilitate patch management, in accordance with one embodiment of the present invention, in accordance with one embodiment of the present invention;

FIG. 6 illustrates an example of an email to notify administrators of new software updates, in accordance with one embodiment of the present invention;

FIG. 7 illustrates a decision tree flow chart to identify new software updates using Microsoft Baseline Security Analyzer (MBSA), in accordance with one embodiment of the present invention;

FIG. 8 is a screen shot showing the use of the SMS administrator console to identify missing software updates and associated bulletin ID numbers, in accordance with one embodiment of the present invention;

FIG. 9 is a screen shot showing a web report listing on which computers available software updates are missing and on which computers the available software updates have already been installed, in accordance with one embodiment of the present invention;

FIG. 10 is a screen shot illustrating the use of the SMS administrator console to determine if a software update is relevant to a particular computer environment, in accordance with one embodiment of the present invention;

FIG. 11 is a screen shot illustrating a web report to identify current compliance levels for a particular security update, in accordance with one embodiment of the present invention;

FIG. 12 is a screen shot illustrating verification of a software update via a digital signature, in accordance with one embodiment of the present invention;

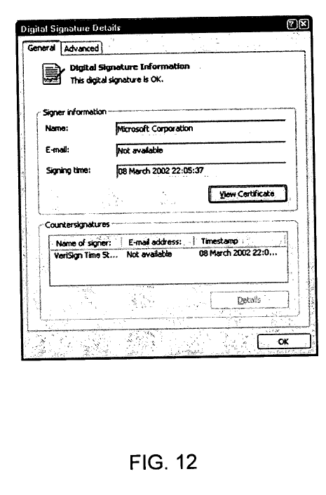

FIG. 13 illustrates an example of a software update deployment timeline;

FIG. 14 illustrates an example of a software update deployment timeline in an emergency update situation, in accordance with one embodiment of the present invention;

FIG. 15 is a screen shot of a reminder associated with an email flagged for a follow-up, in accordance with one embodiment of the present invention;

FIG. 16 is a screen shot of the dialog box for the Advanced button of the Distribute Software Updates Wizard of SMS 2003, in accordance with one embodiment of the present invention;

FIG. 17 is a screen shot of the Import option of the Advanced button of the Distribute Software Updates Wizard of SMS 2003, in accordance with one embodiment of the present invention;

FIG. 18 is a screen shot from the Distribute Software Updates Wizard showing how to import files that have been scanned for viruses, in accordance with one embodiment of the present invention;

FIG. 19 is a screen shot from the Distribute Software Updates Wizard showing how to select the option for postponing installation until a specified deadline, in accordance with one embodiment of the present invention;

FIG. 20 is a screen shot showing how software updates made available through the Distribute Software Updates Wizard will be notified to users, in accordance with one embodiment of the present invention;

FIG. 21 is a screen shot showing selection of the option that permits assignments to be not mandatory over slow links, in accordance with one embodiment of the present invention;

FIG. 22 is a screen shot showing how to create an advertisement configured to download a software update onto a local hard disk and execute it from that location, in accordance with one embodiment of the present invention;

FIG. 23 illustrates an example of an operation checklist table to ensure that an organization has adequate operational processes to support patch management, in accordance with one embodiment of the present invention;

FIG. 24 illustrates an example of a test case including a process stage, a test scenario, test case ID and explanation of required functionality, in accordance with one embodiment of the present invention; and

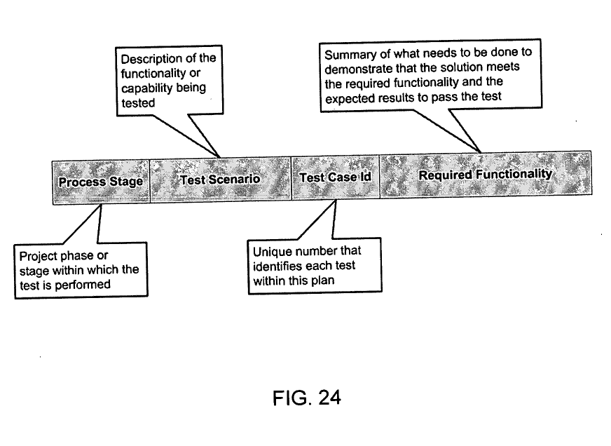

FIG. 25 illustrates a comparison of high level four phase process to the Microsoft Operations Framework (MOF) patch management process model, in accordance with one embodiment of the present invention.

### DETAILED DESCRIPTION

Applicant has appreciated that existing patch management process guidelines have been difficult to follow and implement, and therefore have never gained wide acceptance. The result being that many IT operations still do not follow any discernable process for deploying patches, service packs and the like. Applicant has appreciated that at least one reason a standard and robust approach to patch management has not been widely accepted and used by the IT industry may include a lack of comprehensible instruction on how to build, deploy and maintain an effective patch management process.

In one embodiment, instructions for implementing a patch management process in a networked computer system are provided. The instructions describe the patch management process as having a plurality of top-level activities that may be performed in a generally continuous cycle. The top-level activities include assessing computer assets in the networked computer system to gain an understanding of the software and hardware inventory of the computer system, identifying new software updates for the computer assets in the computer system, planning the release of the new software updates, and deploying the new software updates.

In one embodiment, assessing the computer system is performed distinct from the installation of any particular software update to determine the preparedness of the computer system for future anticipated but unspecified patches. In another embodiment, the top-level assess activity is repeated each time a new software update is deployed. By continually repeating the assess activity, IT operations may be in a position to always know what computing assets are present and how best to protect them against security breaches and other operational vulnerabilities.

In another embodiment, patch management instructions are provided in a hierarchical manner wherein each of the top-level activities includes one more sub-activities to be performed as part of the respective top-level activity. The sub-activities help to refine the patch management process. One of the sub-activities of each of the top-level activities defines a trigger event that transitions the patch management process to the next top-level activity. Defining trigger events may facilitate an understanding of how to implement and administer a patch management process in accordance with the hierarchical structure, and help to ensure patch deployment is executed appropriately.

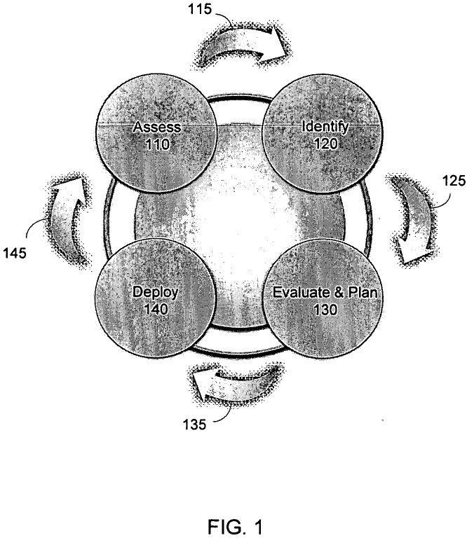

FIG. 1 illustrates a diagram of top-level activities of a patch management process, in accordance with one embodiment of the present invention. The top-level activities include an assess activity 110, an identify activity 120, an evaluate and plan activity 130, and a deploy activity 140. As indicated by arrows 115, 125, 135 and 145, each of the top-level activities transition into a subsequent top-level activity to form a cycle. It should be appreciated that the invention is not limited to the above described top-level activities, as the process can be organized and/or broken down into different top-level activities.

Effective administration of a patch management process may be undermined by the trend to, if at all, perform the assess activity once, or at best to repeat the assess activity only when the computer system has significantly changed or serious problems are encountered. To ensure that current, up-to-date information about the computer system is always available, in one embodiment, the assess activity may be performed as part of the patch management process, which may be repeated in an ongoing cycle.

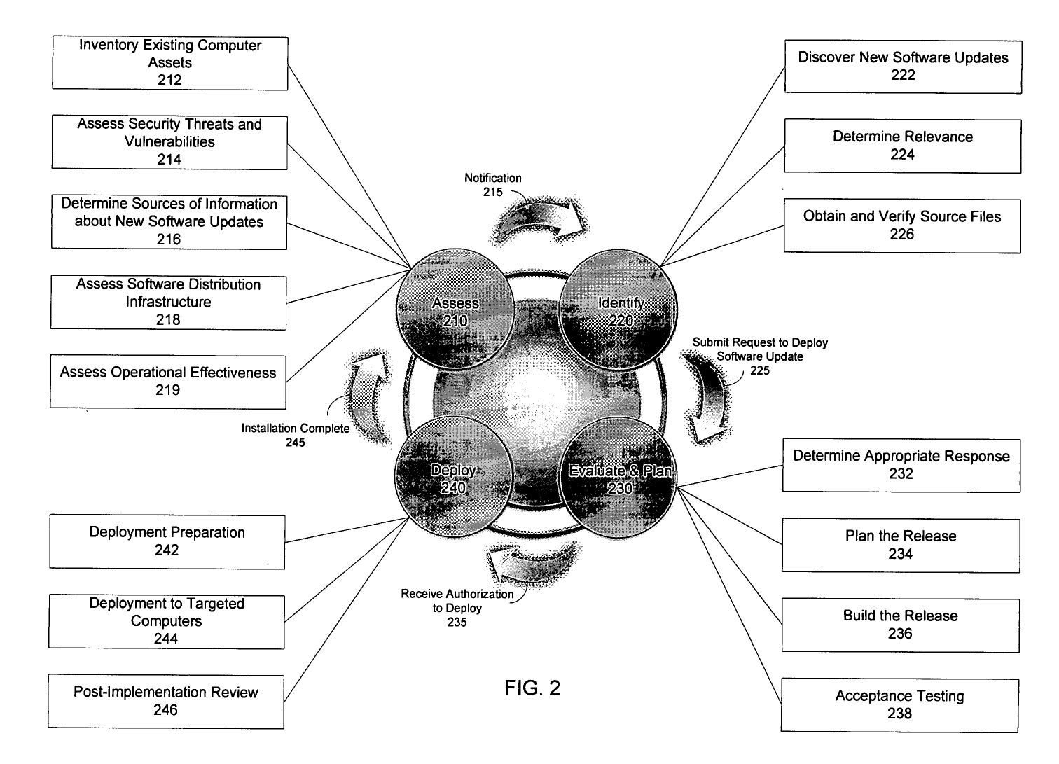

FIG. 2 illustrates a diagram of the exemplary top-level activities similar to those described in patch management process 100 in FIG. 1, including an assess activity 210, an identify activity 220, an evaluate and plan activity 230, and a deploy activity 240. Each of the top-level activities includes a plurality of sub-activities that further refine the process of establishing and administering a patch management process in accordance with one embodiment of the present invention. While the further subdivision of each of the top-level activities into the specific sub-activities shown in FIG. 2 is advantageous for the reasons discussed below, it should be appreciated that the present invention is not limited in this respect, as the top-level activities can be subdivided into any suitable sub-activities.

Top-level assess activity 210 comprises sub-activities including performing an inventory of existing computer assets 212, assess security threats and vulnerabilities 214, determine sources of information about new software updates 216, assess existing software distribution infrastructure 218, and assess operational effectiveness 219. The sub-activities of the assess phase also include notification 215 which operates as a trigger event to transition the process out of the top-level assess activity.

Actions of the inventory existing computer assets sub-activity 212 may include, for example, identifying managed and unmanaged assets, identifying hardware types and versions, identifying operating system types and versions, identifying applications and middleware, understanding connectivity such as the layout of the network infrastructure, capabilities, security, etc., identifying installed and missing software updates, and determining the roles for operations personnel. Sub-activity 212 may include compiling a complete listing of the infrastructure of the computer system, resources, services, and then identifying possible security threats and vulnerabilities.

In addition, sub-activity 212 may include compiling an inventory of the IT resources available for patch management deployment, such as determining the number of personnel in the IT organization, defining the roles for each of the individuals in the IT organization, and determining which individuals are responsible for which tasks. The top-level assess activity and the various sub-activities defined therein may be performed in a generally continuous manner and/or repeated after completing installation of one or more software updates to ensure that the resident knowledge and understanding of the computer system on which the patch management process is being administered is always up to date.

Assess security threats and vulnerabilities sub-activity 214 may include actions that assist in protecting the availability, integrity, and confidentiality of the computer system and its data. Assessing security threats may include actions such as identifying security standards and policies, determining how security policies and standards are to be enforced, and analyzing system vulnerabilities. Identifying security and standard policies may include establishing a definition of how security is to be handled. For example, identifying a security policy may include such things as defining installation standards, identifying minimum security standards, ensuring anti-virus software compliance, defining how various electronic account standards should be handled such as passwords standards and policies, security zoning, etc. A definition of security standards and policies may be followed by defining how the security policies and standards are to be enforced. Sub-activity 214, in general, is performed to establish a security environment for the computer system. Analyzing system vulnerabilities may include performing checks on the various computers in the computer system, regularly and/or periodically scanning computers that may have been infected by a virus and logging reports of these scans, reviewing information reported by monitoring tools, event logs, etc., and maintaining operating system images (baselines) and/or data backups.

Determining the sources of information about software updates sub-activity 216 may include identifying all of the available resources for indicating when a new patch, service pack, software update, etc., is available and ready to be deployed on relevant computer systems. For example, identifying the resources may include subscribing to various e-mail notifications from various hardware and software vendors associated with services on the computer system, locating various websites developed for the purpose of presenting new software updates for download, establishing contact numbers with technical representatives, etc. Determining the best source of information may include subscribing to the various notification methods such that new software patches that become available may be immediately identified, and if appropriate, deployed on the computer system.

Assess the existing software distribution infrastructure sub-activity 218 may include determining whether a software distribution infrastructure is in place, and if so, whether the distribution infrastructure is suitable for distributing software patches, service packs, and other software updates. Assessing the existing software distribution may also include determining whether the current software distribution infrastructure services all computers in the computer system and/or whether the software distribution handles patching of business critical computers or services. Sub-activity 218, in general, ensures that the proper infrastructure for distributing and installing software updates, once they have been identified, is in place and sufficient to service the computer system.

Assess operational effectiveness sub activity 219 may include various activities to determine whether an IT organization is structured and functioning properly. For example, assessing operational effectiveness may include determining whether enough skilled people are in the organization to perform sufficient patch management procedures, ensuring that operations is aware of the importance of patch management, and that operations understands the computer system to be able to appreciate security settings, potential vulnerabilities, software distribution techniques, etc. Assessing operational effectiveness may also include determining whether standard operational procedures are in place, and if so, whether current IT personnel handle day-to-day operations according to the defined standards. Sub-activity 219, in general, includes any of the various tasks of evaluating the various IT processes that are in place in a particular IT organization, identifying any weaknesses, and implementing changes to improve the operational effectiveness of an organization.

Once the assess activity has been performed, computer assets should be inventoried, business critical assets identified and understood, and threats and vulnerabilities to the computer system determined. IT operations should ensure that software distribution tools are available and configured correctly and that personnel are trained and assigned roles and responsibilities and that procedures are in place so that they can respond to, for example, an emergency situation.

As illustrated by notification arrow 215, in the embodiment shown in FIG. 2, the trigger event that signals a transition from the assess activity to the identify activity is notification (e.g., from one or more of the identified and subscribed to resources discussed above) that a new software update exists and is available and ready to be released. This trigger event is an indication that the identify phase has been entered and should be performed accordingly. It should be appreciated that other trigger events may be used to transition the process, as the aspects of the invention are not limited in this respect. The choice of a trigger event to transition the process from one top-level activity to the next may depend, at least in part, on the particular breakdown of top-level activities.

Top-level identify activity 220 may include discover new software updates sub-activity 222, determine the relevancy of the software updates sub-activity 224, and obtain software update source files sub-activity 226. In the embodiment in FIG. 2, the identify activity also may include submitting a request to deploy the software update 225, which operates as a trigger event to transition from the identify phase to the deploy phase.

Discover new software update activity 222 may include receipt of a notification from one or more of the resources identified during the assess activity. For example, notification by e-mail is a common form of patch notification. In addition, IT personnel may be given the responsibility of checking available websites to make sure that newly released software updates are identified. A combination of the various notification techniques may be used such that software updates for one or more of the assets assessed during the inventory stage are identified as close to the time when the software updates are made available as practicable.

Determine the relevancy of the software updates sub-activity 224 may include identifying whether a particular software update upon which notification has been received is appropriate for the computer system on which the patch management process is administered. For example, a large number of software updates may be regularly released by various software vendors to the IT organizations that have subscribed to the notification facility. However, each of these software updates may not be relevant to a particular computer system. If a software update is not relevant to a particular computer system, the time and resources necessary to release and deploy the software update should not be wasted by IT operations. For example, a security update might be released and a notification sent out wherein the update is designed for all Windows servers operating Internet Information Services (IIS) with Active Service Pages (ASP) enabled. While a particular environment may contain several Windows servers, the security update may not be relevant if the particular computer system does not have ASP enabled. By ensuring that a software update is relevant, the effort required to maintain a patch management process and to keep a computer system up-to-date and secure may be minimized.

Obtain software update source files sub-activity 226 may include obtaining the identified software update and confirming that the update is safe and will install successfully on the computer system. The verification process may include verifying the identity of the distributor of the software update, reviewing the software update files, software update size, and software update dependencies, verifying that software update installation and uninstall procedures exist, establishing that the software update is free from viruses, etc. In one embodiment, the validity of a software update and its ability to be installed on a particular computer system is not taken at face value. For example, some sources might send a virus disguised as a software update or security notification. In addition, the size of an update, possible dependencies, and other circumstances may make it undesirable to install a particular software update on the computer system.

After a software update has been identified, obtained, verified and validated, and it is determined that the software update is safe to deploy, in one embodiment, the software update may be flagged as a normal deployment of a software update or an emergency deployment of the software update, depending on its urgency. The deployment may be categorized into any number of urgency levels, as the aspects of the invention are not limited to the two (i.e., normal and emergency) levels described above. When the software update has been flagged, a request to deploy the software update may be generated. In the embodiment of FIG. 2, generating a request to deploy the software update 225 functions as the trigger event that transitions the patch management process into the subsequent evaluate and plan phase. Once the request has been submitted, the patch management process continues to be performed in the evaluate and plan phase. As discussed above, different trigger events may be used to transition the process from one phase to the next, as the aspects of the invention are not limited to use with any particular trigger event(s).

Top-level activity evaluate and plan 230 may include sub activities to determine the appropriate response to a new software update 232, plan the release of the software update 234, build the release 236 and conduct acceptance testing of the release 238. The evaluate and plan activity also includes a trigger event characterized by receiving approval to deploy the software update. After approval has been received, performance of the process may continue in the subsequent deployment phase.

Determine appropriate response sub-activity 232 may include prioritizing and categorizing the request and obtaining authorization to deploy the software update. Although priority and category may be assigned in the request to deploy the software update, the assignment should be reviewed and verified before authorization. A request may be prioritized in order to determine how quickly a software update needs to be deployed. Determining the priority may include determining which, if any, critical business assets may be exposed to a potential security breach or system instability if the software update is not installed. Other factors involved in prioritizing a software update may include whether counter measures have been deployed to minimize exposure to a particular security vulnerability and/or what the threat of the vulnerability in question is to the computer environment.

One method of organizing the priority is to define time frames for different priority levels. For example, an emergency priority assessment may be recommended to be deployed within 24 hours and, at minimum, within two weeks. A high priority assessment may recommend deploying software update within a month and, at a minimum, within two months. A medium priority assessment may include a recommendation of deploying the software update within four months and include a minimum recommendation for deploying the software update within six months. A low priority setting may include a recommended time frame of deploying the software update within a year, and if not within the year, then not at all.

Factors that may influence the priority assessment include the high value or high exposure of the assets that are impacted, whether the potentially impacted assets are historically targeted by attackers, and/or mitigating factors such as counter measures that are currently deployed, etc. It should be appreciated that the above priority assignments and deployment times are merely exemplary, as different priorities, levels and deployment times may be used.

Categorizing a software update may assist in understanding the impact the software update will have on the systems and services within the computing environment. Determining the category may include such actions as determining which machines the software update will be installed on, and the business criticality of those machines, determining if any preliminary actions should be taken such as installing a service pack before installing the software update, determining whether the software update can be uninstalled, establishing which services should be stopped or paused during the installation, determining the impact on the network infrastructure, etc.

Obtaining authorization to deploy the software update may include determining who should be involved in the decision making process to deploy the software update. For example, depending on the priority and category of the software update, any one of or combination of representatives having an interest in the computer system may be included in the decision making process and may be consulted to obtain authorization to deploy the software update. Obtaining authorization may also include assessing the risks and consequences of deploying the software update such as determining what else is happening in the computing environment, estimating anticipated costs, determining any preliminary steps necessary to mitigate exposure, reviewing the impact of computer downtime, determining the best and most effective mechanism for deploying the update, identifying known issues or side effects of the software update, deciding whether there are enough resources available to deploy the software update, and identifying any dependencies or prerequisites or activities needed to be carried out before the software update can be deployed.

Obtaining authorization also may include determining what individuals or what group will be responsible for deploying the software update. The identified group may develop a plan for making the required changes, determine and obtain the necessary resources, arrange for the development of any necessary scripts, tools, and/or documentation, ensure that adequate testing is carried out, and ultimately ensure that appropriate changes to facilitate installation of the software update are deployed into the computer environment. By designating an individual or group of individuals as owners of the software update, the likelihood of efficient and effective deployment of the update may be increased.

Plan the release of the software update sub-activity 234 may include such actions as determining the resources to be patched, and identifying the key issues and constraints. Determining the resources to be patched may require accurate and up-to-date knowledge of what assets and resources are present in the environment (e.g., the various assets and resources identified during the assess phase) and the type and role of the machines that are to be patched and their relationship to the network. Identifying the key issues and constraints may include determining when users of the computer system should be notified about the software update and how much time should be allocated before the software update is installed automatically.

Some software updates may require administrative rights that many end users may not possess. Accordingly, some key issues may involve identifying in what instances an administrator may need to acquire elevated rights and privileges to install the software update on client computers. In addition, client computers may be constrained with regard to the amount of disk space available for installation of the software update. Other constraints include download time for large software updates, postponement of installation for mobile clients until they are no longer physically connected to the network, etc. Further issues to consider may be locked down computers, group policies and other security issues that may influence whether a software update will install correctly.

Build the release sub-activity 236 may include such actions as developing scripts, tools and procedures for deploying the software update. For example, building the release may include creating a batch file or program either from scratch or using an authoring tool in order to deploy the software update or the software update may be deployed using available automatic update packages such as the SMS 2003 Distribute Software Updates Wizard.

Acceptance testing of the release sub-activity 238 may include checking that the software update works in an environment that closely mirrors the computer environment on which the software is intended to be deployed, and that business critical systems continue to operate correctly during the update in the test environment. Tests that are carried out during this sub-activity may include ensuring that a computer reboots after the installation is complete, ensuring that the software update may be downloaded across slow and/or unreliable network connections and that download over such links is followed by a successful software update installation, ensuring that the software update is supplied with an uninstalled routine, and that business critical systems continue to operate once the software update has been installed. Acceptance testing may also include rolling out the software update into a small representative sample or subset of the computers in the computer system to confirm that business critical systems and other applications continue to run correctly, and so that other issues can be identified before the software update is deployed to the entire computer system.

The evaluate and plan activity may include a formal process to determine whether it is appropriate to deploy a software update, procedures to identify who will be responsible for deploying the software update, a plan as to how to deploy the software update, building the software update package for deployment, and testing the software update package in a lab and/or in a pilot environment to confirm that the software update installs correctly. After testing has been completed, and the package is ready for deployment, approval for the deployment of the software update may be received. In the embodiment of FIG. 2, receiving approval to deploy the software update functions as a trigger event to transition from the evaluate and plan phase to the deployment phase. Different trigger events may be used, as aspects of the invention are not limited to any particular trigger event.

Top-level deploy activity 240 may include deployment preparation sub-activity 242, deployment to targeted computers sub-activity 244, and post implementation review sub-activity 236. In the embodiment of FIG. 2, completing installation of the software update operates as the trigger event associated with the top-level deploy activity, as illustrated by trigger arrow 245. After the software update is deployed, the patch management process transitions back to the top-level assess activity 210 and the cycle may be repeated.

Deployment preparation sub-activity 242 many include communicating the roll out schedule to the organization, importing programs and advertisements from the test environment, assigning distribution points, staging updates on distribution points, and selecting deployment groups. End users and administrators may be informed about the impending release of an update, for example, via an email message. The programs and advertisements used in the test environment may be imported such that the test environment and the computer system on the which the software update is to be deployed are as similar as is practicable. Once the software update package has been imported, distribution points may be used to make the software update available to the various resources that comprise the target computer system.

Deployment to targeted computers 244 may included installing the update on a targeted group of computers to ensure that the installation works as intended. Deployment of the software update to targeted computers may be monitored and reports made on the progress of the deployment. In addition, any failure in the deployment of the installation may be identified and remedied.

Post implementation review 236 may include various actions items geared to assist in assessing the effectiveness of the deployment, such as planned versus actual results and the general performance of operations in deploying the software update. The post implementation review may also include various actions designed to make sure the computer system is updated, such as ensuring that build images include the software updates so that computers receiving the image are up-to-date with respect to the latest software updates.

The top-level deploy activity may include any of various tasks involved in installing the new software update on the computer system. In the embodiment in FIG. 2, a completed deployment of the new software update triggers a transition into the subsequent phase. As illustrated in FIG. 2, this transition results in a return to the assess phase. Accordingly, the patch management process forms a cycle which may be repeated in a substantially continuous fashion. In this way, a computer system may be continually prepared for future software patches and up-to-date knowledge and understanding of the computer system's resources, assets and vulnerabilities may be maintained on an ongoing basis.

It should be appreciated that one or any combination of sub-activities may be implemented in a patch management process in any combination. Administering a patch management process is not limited to performing each of the activities described above and may be performed using one or any combination of activities. In some patch management processes, one or more activities may not be necessary or desirable and may not need to be performed. In addition, each activity need not be limited to the particular sub-activities described above and transitions are not limited to the trigger events described above, as the invention is not limited to the foregoing example.

In one embodiment described below, a patch management process provided for use with the Microsoft Operations Framework (MOF), which provides guidance that enables organizations to achieve system reliability, availability, supportability, and manageability for a wide range of management issues pertaining to complex, distributed, and heterogeneous environments. MOF includes a number of service management functions (SMFs) that provide operational guidance for implementing and managing computing environments and other IT solutions. In one embodiment, patch management instructions are provided as a MOF SMF. The patch management SMF is presented in accordance with the fundamental principles of MOF and may be fully integrated with other MOF SMFs. A complete description is provided in the published Microsoft Patch Management Using Microsoft Systems Management Server 2003 documentation, which is herein incorporated by reference in its entirety.

It should be appreciated that the discussion below regarding a use of a patch management process for use with MOF is provided simply as an example, as the embodiments of the invention described herein are not limited to use with MOF, Microsoft products and technologies, or any other particular platform or environment. In addition, various activities and actions described below in the context of MOF may be used in any combination with, but do not limit other embodiments described herein.

As discussed above, patch management is a process that gives an organization control over the deployment and maintenance of interim software releases into their production environments. It helps organizations maintain operational efficiency and effectiveness, overcome security vulnerabilities, and maintain stability of the production environment. Organizations that cannot determine and maintain a known level of trust within their operating systems and application software might have a number of security vulnerabilities that, if exploited, could lead to loss of revenue and intellectual property. Minimizing this threat requires organizations to have properly configured systems, to use the latest software, and to install the recommended software updates.

The following are some areas to consider when determining the potential financial impact of poor patch management:
Downtime. What is the cost of computer downtime in your environment? What if critical business systems are interrupted? Determine the opportunity cost of lost end-user productivity, missing transactions on critical systems, and lost business during an incident. Downtime is caused by most attacks, either by the attack itself or by the corresponding remediation required when recovering. Some attacks have left computers down for several days.
Remediation time. What is the cost of fixing a wide-ranging problem in your environment? How much does it cost to reinstall a computer? What if you had to reinstall all your computers? Many security attacks require a complete reinstallation to be certain that back doors (permitting future exploits) were not left by the attack.
Questionable data integrity. In the event that an attack damages data integrity, what is the cost of recovering that data from the last known good backup, or confirming data correctness with customers and partners?
Lost credibility. What does it cost if you lose credibility with your customers? How much does it cost if you lose one or more customers?
Negative public relations. What is the impact to your organization from negative public relations? How much could your stock price or company valuation fall if you are seen as an unreliable company to do business with? What would be the impact of failing to protect your customer's personal information, such as credit card numbers?
Legal defenses. What might it cost to defend your organization from others taking legal action after an attack? Organizations providing important services to others have had their patch management process (or lack of one) put on trial.
Stolen intellectualproperty. What is the cost if any of your organization's intellectual property is stolen or destroyed?

Assessing and maintaining the integrity of software in a networked environment, through a well-defined patch management program, is a key first step toward successful information security, regardless of any restrictions to physical access to a computer.

In one embodiment, a patch management processes provides architectural, developmental, operations, and test guidance for deploying software updates to operating systems and installed applications using Microsoft® Systems Management Server (SMS) 2003. The patch management process provides conceptual information, design and configuration best practices, and details of the operational practices that facilitate successful preparation, installation and administration of software updates and patches.

Effective Operations

MOF, the MOF Process Model, the MOF service management functions (SMFs), and the MOF Team Model provide guidance for effective IT operations. Three of the SMFs—Change Management, Configuration Management, and Release Management—are especially crucial to patch management.

For more information about the MOF Process Model, the SMFs, and the MOF Team Model, see http://www.microsoft.com/technet/treeview/default.asp?url=/technet/itsolutions/msm/default.a sp.

Tools and Technologies

Organizations of all sizes should use automated tools that assist administrators in managing and controlling software update installation.

Systems Management Server 2003

Microsoft Systems Management Server (SMS) 2003 is the preferred mechanism for deploying and managing the distribution of software updates to a large number of clients. It provides the following functionality, which is essential to successful deployment:
Inventory functions to determine how many computers have been deployed and to identify their locations and roles.
Inventory functions to identify which software applications and software updates have been installed and which need to be installed on the deployed computers.
Scheduling functions that allow an organization to deploy software updates outside regular working hours, or at a time that has the least impact on business operations.
Status reporting that allows administrators to monitor the progress of installation.

The SMS 2003 inventory scanning programs are key to effectively managing software updates. SMS 2003 inventory scanning programs are used to create an inventory of applicable and installed updates for each client computer using an automated source of detection logic. The resulting data is included in the Systems Management Server inventory and a comprehensive view of the status is provided through the Web-based reporting capabilities. Typically, the inventory data will be limited to those items that are released by Microsoft as a security bulletin.

Microsoft Baseline Security Analyzer

Microsoft Baseline Security Analyzer (MBSA) scans for missing security updates and reports on a computer's adherence to common security best practices (such as strong passwords), and identifies any configuration options that leave the computer open to potential security vulnerabilities.

Note that, although MBSA offers the capability of identifying on a domain level/subnet level what is required to secure a particular computer, it does not provide any method for distributing the updates to those computers or configuring the computers. It provides information on how to remediate any vulnerabilities found including links to Knowledge Base articles and white papers.

More information on MBSA can be found at http://www.microsoft.com/mbsa.

Effective Project Management Processes

In order to get the best results, you should treat your use of the Microsoft-preferred patch management process outlined in this solution accelerator as a project, using an effective project management process.

Many organizations have their own methodologies, all of which should be compatible with the guidance provided in this document. Microsoft recommends using Microsoft Solutions Framework (MSF) for project management guidance. More information about MSF can be found at www.microsoft.com/msf. Some MSF-based project guidance is also provided in Appendix A, “Project Guidance.”

Solution Guidance

Overview

The Microsoft-recommended patch-management process is a four-phase approach to managing software updates, which is designed to give your organization control over the deployment and maintenance of interim software releases into your production environment. Those phases are:
Assess

The process starts with Assess, because you will need to determine what you have in your production environment, what security threats and vulnerabilities you might face, and whether your organization is prepared to respond to new software updates.
Identify

Your goal during the Identify phase is to discover new software updates in a reliable way, determine whether they are relevant to your production environment, and determine whether an update represents a normal or emergency change.
Evaluate and Plan

Your goal during the Evaluate and Plan phase is to make a go/no-go decision to deploy the software update, determine what is needed to deploy it, and test the software update in a production-like environment to confirm that it does not compromise business critical systems and applications.
Deploy

A goal during the Deploy phase is to successfully roll out the approved software update into your production environment so that you meet all of the requirements of any deployment service level agreements (SLAs) you have in place. FIG. 1 illustrates four phases of one embodiment of a patch management process.

This four-phase process is based on the MOF Change Management, Release Management, and Configuration Management service management functions (SMFs), which can be found at http://www.microsoft.com/technet/treeview/default.asp?url=/technet/itsolutions/msm/default.a sp. Appendix B, “Mapping Patch Management to MOF,” illustrates how the four-phase process maps to the patch management process flow chart that originally appeared in a previous version of this patch management solution accelerator.

Assess

Overview

The Assess phase is the first major step in the patch management process. Ideally, it is an ongoing process that you should follow to ensure that you always know what computing assets you have, how you can protect them, and how you can ensure that your software distribution architecture is able to support patch management.

The remainder of this section will focus on the key requirements for ongoing assessment. Those requirements are:
Inventory/discover existing computing assets
Assess security threats and vulnerabilities
Determine the best source for information about new software updates
Assess the existing software distribution infrastructure
Assess operational effectiveness

Inventory/Discover Existing Computing Assets

From a patch-management automation perspective, there are two types of inventory targets. Systems that are managed using a management tool such as SMS are categorized as managed infrastructure. Those that do not have a working agent, or have been purposefully excluded from management automation, are considered unmanaged infrastructure. Unmanaged infrastructure may include such systems as:
Security systems, external and DMZ hosts, and known systems in specific environments such as test and development.
Stand-alone computers.

Unmanaged assets still need to be addressed by patch management. You need to check these systems to make sure the latest software updates have been installed. You might need the help of the computer administrator to do so. In some cases, Microsoft Windows® Update might be the most effective way to deploy software updates into such systems.

Identifying the needs of stand-alone computers or computers that are not members of a domain under your control can be challenging. Without local administrative rights to these unmanaged clients, collecting system information beyond computer name and IP address can rove very difficult. However, this basic information can serve as the basis for identifying unmanaged clients in your environment.

Note For systems based on Microsoft Windows, Microsoft Baseline Security Analyzer (MBSA) will report the names and IP addresses of computers that it cannot scan.

What Information Needs to Be Collected?

Effective patch management requires accurate and current knowledge of what hardware and software has been deployed within the production environment. Without this information, you will not be able to determine which computers within your environment require a software update. It is also important to determine the manner in which client computers are connected to the network. If some connect through slow or unreliable links or use remote access—dial-up facilities, for example—the method of distributing and installing a software update will differ from the method used for computers that are connected to a fast, reliable network.

The following sections outline the information that needs to be retrieved from computers deployed within the production environment in order to perform effective patch management.

Identifying Hardware Types and Versions

Understanding whether a computer is a laptop (mobile client), desktop, or server will help administrators determine how a particular software update needs to be installed. If you are patching a server, for example, you may need to observe outage windows (specific times at which changes and computer restarts are permitted) or ensure that the server is backed up before you deploy the software update.

SMS allows you to create collections that contain servers that can be patched within a specific outage window, which ensures that software updates are not installed during normal business operations. If you create a database that lists servers and the outage windows that apply to them, you can create a program that automatically creates the collections you need. More information about how to do this is contained in the SMS 2003 SDK, which is located at http://www.microsoft.com/downloads/details.aspx?FamilyId=6150FB42-03D7-400C-92FD-A2FE3BE997D1&displaylang=en.

By default, the information the SMS 2003 Hardware Inventory Client Agent collects is sufficient for distinguishing portable computers from other computer types. However, there is no single attribute or collection of attributes that can clearly identify the type or model of the computer.

Identifying Operating System Types and Versions

Administrators need to be aware of all operating system (OS) types and versions that have been deployed into the production environment. MBSA will report on missing security updates and service packs and will identify vulnerabilities for installations of Windows Server™ 2003, Windows XP, Windows 2000, and Windows NT® 4.0. It will also report on whether the computer configuration adheres to common security best practices (such as strong passwords).

Identifying Applications and Middleware

As with the operating system and service pack version, administrators need to be aware of all deployed software applications and versions. The SMS 2003 Hardware Inventory Client Agent can be used to collect information about all installed applications, service packs, and software updates that have registered in the Windows Add/Remove Programs program.

For those applications that do not register in Add/Remove Programs, you should use SMS 2003 Software Inventory Client Agent to obtain details of every executable (.exe) file installed on client computers. Additional work will be required to analyze this inventory to determine which products have actually been installed. In general, software inventory should be configured to occur weekly for all computers in the production environment. Your requirements may be different.

For some applications, you might have to extend the information collected by SMS 2003 Software Inventory Client Agent to obtain more details about an installed version of a software application in order to select the most appropriate software updates. Inventorying Internet Explorer, for example, is more involved than just reviewing the information that is collected by SMS for the Iexplore.exe file through the standard inventory process. The only accurate way to retrieve Internet Explorer version information is to cause SMS to inventory the registry key on the computer that holds the Internet Explorer data. The registry keys contain information that SMS can use to inventory which software updates and service packs have been installed. To allow SMS to inventory the registry key, you must modify the SMS_def.mof file to include a Registry Provider (a bit of code that gives SMS access to the registry). See Appendix C, “Modifying SMS_def.mof to Inventory the Registry,” for an example of modifying the SMS_def.mof file.

Determining Roles

It is essential to determine the role of a computer because administrators need this information to determine the impact of restarting the computer once a software update has been deployed. For example:
If the computer is a server running a business-critical application, you might have to reschedule the installation of a software update during periods when it will have minimal impact on your business. It also may be necessary to make arrangements for business continuity, for example, so that users can continue to make use of the application while the server is being restarted.
If the computer is a domain controller holding one or more of the operations master roles (also known asflexible single master operations or FSMO), you will need to move these roles to other domain controllers within the domain while the computer is being patched. You should restore the roles back to the original computer when it restarts successfully.

The information the SMS 2003 Hardware Inventory Client Agent collects by default is sufficient to determine which services are running on a computer. However, it may be necessary to modify the SMS_def.mof file to collect additional information from the registry, as shown in Appendix C, “Modifying SMS_def.mof to Inventory the Registry.”

Understanding Connectivity

Understanding the layout of your network infrastructure, its capabilities, security level, link speed, and link availability is important for effective patching. Software updates can vary in size and knowing the constraints of your network infrastructure can potentially reduce any delays in distributing software updates. It can also dictate the manner in which the software update will be deployed to particular client computers. You can use Microsoft SMS Network Discovery to provide information on the network topology and the devices connected to the network. More information can be found in product documentation available at http://www.microsoft.com/smserver/techinfo/productdoc/default.asp.

Identifying Installed and Missing Software Updates

Identifying which software updates have or have not been installed on computers is essential. SMS 2003 provides mechanisms to identify which software updates are missing from specific servers and desktops.

Identifying Required Software Updates

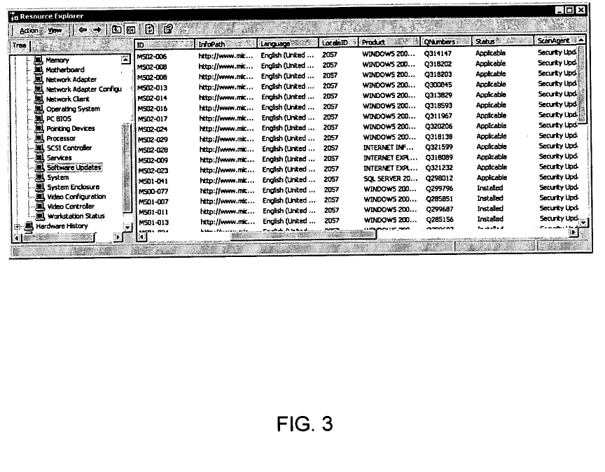

Administrators can use the Security Updates Inventory Tool provided in the Software Update Management feature of SMS 2003 to extend SMS hardware inventory to report on the software updates that need to be installed on a set of clients, as shown in FIG. 3. SMS 2003 clients compare what has been installed against the list of available software updates contained in the extensible markup language (XML) file downloaded from the Microsoft Update Web site.

FIG. 3 illustrates adding security update information to the SMS database. The installation routine for the Security Updates Inventory Tool also creates a recurring advertisement (running every seven days) that downloads the latest software update catalog (Mssecure.cab) file from the Microsoft Update Web site. The site server automatically creates a new advertisement, which is targeted at all the client systems collection, once download is complete. This advertisement runs the Security Updates Inventory Tool for updates using the latest software update catalog file.

The SMS 2003 Security Updates Inventory Tool will not report on missing service packs. You will need to use SMS hardware and software inventory client agents to discover the currently installed service pack. It is always advisable to baseline your organization at the latest service pack and patch from this point onwards. Additionally, the security patch reports are solely based on the current service pack revision—for example, software updates relating to SP2 will not display in the report if the current service pack is SP1.

Identifying Required Office Software Updates

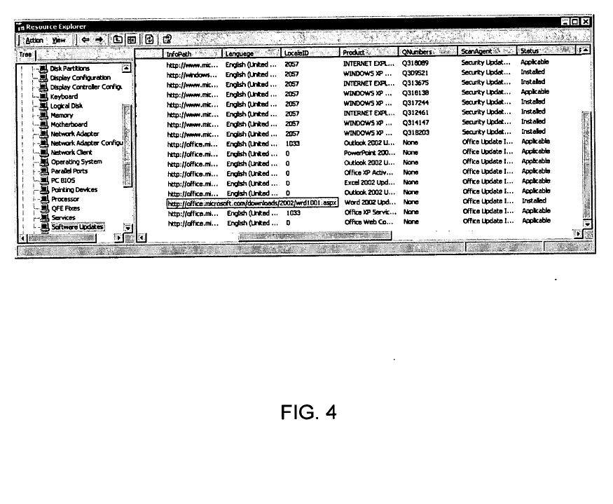

Administrators can use the Microsoft Office Inventory Tool for Updates, which is provided in the Software Update Management feature of SMS 2003 to extend SMS hardware inventory to report on the software updates required to keep Office current. As shown in FIG. 4, client computers compare what has been installed against the contents of the latest Office Update Database (invcif.exe) file in a process similar to that of the Security Updates Inventory Tool mentioned earlier. FIG. 4 illustrates adding Office update information to the SMS database.

The Office Update Inventory Tool uses the Office Update Tool with the Office Update Database (invcif.exe) to analyze your client computers for applicable Office updates. The data gathered by the Office Update Tool is then converted into a format compatible with the SMS site database. The office Update Sync Tool automatically downloads the latest version of this tool on a regular basis and distributes it to the computers in your enterprise by using SMS distribution points. For more information about the Microsoft Office Update Tool, see http://support.microsoft.com/?kbid=312982.

Conducting Inventory/Audit

An audit helps an organization understand and gain an accurate record of its production environment prior to determining baselines using the tools previously identified. You should also add the results of the audit up to this point to your organization's central repository for tracking information about your production environment. This will act as a dual reference point, ensuring the audit is not only correct, but also that you have updated your repository. You should note any differences between the audit result and the repository record and pass that information to your problem management team for investigation. Problem management team members should attempt to determine the point of failure in the recording of the information and develop a workaround, if necessary, to prevent similar instances in the future.

Accurate and up-to-date information of what is present in the environment is essential for patch management. Administrators need to check that the audit has been done before they can begin to use information stored in the SMS database to support patch management tasks and activities.

The first step in checking audit success is to confirm that the Microsoft Office Inventory Tool for Updates and Security Updates Inventory Tool in SMS 2003 have run successfully. To achieve this, SMS administrators should check the status messages of the advertisement to see if there have been any failures. SMS client computers that have not run the update inventory tools should be reported to problem management.

Having confirmed that the scanning tools have run successfully, administrators should then check the status of hardware and software inventory on each SMS client. To this end, they should create a Web report that lists SMS client computers on which the hardware and software inventory client agents have failed to install or those on which they have failed to run within a specified time period (each day for data center-class computers, each week for all others). As an example, you can use the Computers that have returned software update error messages for a specified advertisement report under the Software Update-Infrastructure Health category in SMS 2003. All computers appearing on this report should be referred to problem management.

Creating an advertisement for the expedited versions of the scanning tools can force hardware inventory to occur once the scan for missing updates has been completed. By default, the information obtained by these tools will be reported to the SMS site server at the next scheduled hardware inventory cycle.

Analyzing Inventory Data for Completeness

Once they receive inventory information, administrators need to check it for completeness and to ensure that all managed computers have reported up-to-date inventory. The following activities should be performed on the inventory data:
The inventory results should be compared with prior inventory, and an increase or decrease in computers detected noted. A significant shift in the counts as compared to prior inventory runs may indicate a gap in completeness.
The inventory results should also be compared against machine objects (computer accounts) in Microsoft Active Directory® directory service domains. As long as stale accounts are cleaned up, this will be as useful as comparing against name resolution services mentioned in the next bullet.
Systems in active use will register and use the name resolution services—Windows Internet Name Service (WINS) and Domain Name System (DNS)—in your environment. Scripts that cross-reference against active infrastructure such as these services may give a comprehensive view of how complete the inventory for patch management is. Ensure that scavenging or clean-up of stale records is enabled on your name resolution servers to obtain more accurate results.

If analysis discovers a discrepancy in the information returned, you should investigate further to determine the cause and take steps to ensure that systems missed by SMS inventory are added to the SMS database.

Baselining an Environment

A baseline is a set of documented configurations of a product or system that is established at a specific point in time. Baselines establish a standard that systems of the same class and category need to match. Effective IT operations use baselines as a trusted point from which systems are built and deployed. Typically, the configuration defined by a baseline is stringently tested and vendor-certified.

An application or software baseline provides the information needed to rebuild a system to a desired state. It might be necessary to establish baselines for different software applications, hardware vendors, or types of computers.

Baselining requires that you perform and maintain an accurate inventory of the computers and services within your environment. Keep in mind the following points when establishing baselines for your environment:
Infrastructure that falls below the baseline needs to be addressed through problem management. You should bring all the computers that have been identified as below the baseline up to compliance. These computers may have had issues with distribution, schedules, permissions, or may require special care through exception handling.
Infrastructures that exceed the baseline are not necessarily at an advantage. Computers exceeding their class baseline should be checked to determine if unauthorized changes have occurred. In some cases, it may be necessary to return a system to a trusted level or it might be appropriate to control it through a change freeze. Systems that exceed an approved baseline contain application versions or software updates that have not been tested, for interoperability and formally approved by IT Operations and IT Security.
Some systems may have special circumstances that make them exempt from their class's baseline. For example, an older workstation running a legacy payroll application that connects to a processing agency by means of a modem may require an operating system level far below the established baseline. It may not be appropriate to upgrade this system to the latest baseline since this could prevent the legacy application from running.

Assess Security Threats and Vulnerabilities

Once you understand what computer systems and data have been deployed in the production environment, you should carry out an ongoing security assessment to determine the steps that should be taken to protect the availability, integrity, and confidentiality of computer systems and data. At a minimum, the security assessment needs to cover the following:
Identifying security standards and policies.
Determining how security policies and standards are to be enforced.
Analyzing system vulnerabilities.

For more detailed information about performing a security assessment, see “Understanding the Security Risk Management Discipline” at http://www.microsoft.com/technet/security/prodtech/windows/secwin2k/03secrsk.asp.

Identifying Security Standards and Policies

An effective security policy should identify the minimum security standards for computers and help minimize exposure to potential security vulnerabilities. To be effective, an organization's security policy should be reviewed whenever changes are made to IT systems and software within the production environment and include, at a minimum, the following items:
Installation standards, describing supported installation locations and methods.
Network and domain standards, indicating how names and Transmission Control Protocol/Internet Protocol (TCP/IP) information is assigned and which domains computers should join.
Operating system security options and policy settings, including those for reducing open ports based on required services.
Any standards that describe the use of encrypted file systems.
Minimum service pack or software update compliance, updated with each security release.
Antivirus software compliance.
Application security configuration settings, such as macro file protection and security zones.
Administrative account standards, such as renaming or disabling accounts and setting up decoy accounts.
Strong password standards.

A security policy violation suggests a vulnerability that should be eliminated from the environment. The vulnerability could be the failure to use strong password by a user or a computer that lacks required security updates or is not configured correctly.

The security policy may provide guidelines for each type of policy-compliance violation; this can then be used to determine the severity of an incidence of a specific vulnerability. Microsoft Baseline Security Analyzer (MBSA) scans for security updates and common security misconfigurations. It does not scan for conformance with all elements of an organization's security policy.

After you have established and activated a security policy that defines computer security standards, you should apply the strategies presented in the following section to address any discovered violations or vulnerabilities through a series of escalations.

Determining How Security Policies and Standards are to be Enforced

Enforcing security policy can be complicated by distributed administration and vulnerable assets that are not centrally managed. Those responsible for administering the asset and resolving the vulnerability may be unknown or hard to find, may physically reside within another department in the organization, or may not have the necessary skills to resolve the vulnerability on their own.

For more information about how the Microsoft Operations and Technology Group (OTG) manages vulnerabilities, see Managing Computer Vulnerabilities at Microsoft at http://www.microsoft.com/technet/itsolutions/msit/security/mscomvul.asp.

Accordingly, there are several practices that become necessary and helpful when it comes to enforcing security policy:
Security policies, enforcement timelines, and approaches should have the support of management across the entire organization.
Techniques and tools for determining ownership and administrative information on an unmanaged computer should be available to specific service desk technicians.
Service desk technicians should be trained on mitigating each of the vulnerabilities that violate security policy.
Automated tools and techniques—such as Group Policy—should be used to ensure that computer systems are continually in compliance with corporate security policy and standards.

The nature of a security vulnerability, such as the risk of exploitation and the cost of recovery, should help determine how aggressive the response should be to a system that is not in compliance. If attempts to resolve the vulnerability within the required timeline are unsuccessful, you may choose to employ more aggressive tactics, including:
Escalating the issue within the violator's organization.
Disabling the primary account that is used to access the computer.
Removing the computer from the network by physically disconnecting it or configuring network hardware to automatically remove the device from the network—by disabling ports, for example.

These last two tactics will typically result in a call to the service desk, where the unresolved vulnerability can be discussed and an acceptable resolution determined. Be sure to have executive support for the security policy before escalating security violations and attempting these techniques.

Analyzing System Vulnerabilities

Ongoing scanning and reporting of security issues is crucial for ensuring that potential security vulnerabilities are identified and addressed. At a minimum, organizations should perform the following actions:
Perform checks on computers deployed within the production environment, and check the operating system and other installed components, such as Microsoft Internet Information Services (IIS) and Microsoft SQL Server™, for configurations that may compromise security. You can use the Microsoft Baseliner Security Analyzer (MBSA) to identify many security misconfigurations, but you should also check the Microsoft Security and Privacy Website for more information on computer hardening and security. That site is located at http://www.microsoft.com/security.
Regularly scan and identify computers that may have been infected by a virus. You can create these reports using the virus tools your organization has selected.
Review information returned by network monitoring tools, event logs, and other monitoring tools and the output of any intrusion detection system to determine whether attacks are being made against computer systems within the production environment.
Create and maintain operating system images (baselines) that can be applied to a given hardware platform to quickly revert a compromised system to a known good operating system.
Check that all users and administrators are aware of the steps they need to take in the event of an attack on computer systems within the production environment.
Maintain a prioritized list of all key information and assets that need to be protected first should an attack occur.
Verify your router and firewall logs and configurations to ensure they are consistent with your organization's given standards for these devices.
Review domain controller security policies.

Scanning systems for potential security vulnerabilities should be as automated as possible and performed on a regular basis—daily for most systems. If you discover that a security vulnerability has been exploited, then you need to carry out an emergency response process to minimize the impact. An example of some of the steps that might be included in this response can be found in Appendix D, “Emergency Security Response.”

Determine the Best Source for Information About Software Updates

Once you know what you have deployed in your production environment and have assessed security threats and vulnerabilities, you need to determine the best source of information about new software updates. This information will be used in the following phase when you identify new software updates. Sources of information about software updates can be:
E-mail notifications.
Web sites.
Microsoft technical representatives.

Subscribing to the proper notification methods is essential to maintaining and updating your established operating baselines and for implementing an efficient patch management process.

Assess the Existing Software Distribution Infrastructure

Assessing the software distribution infrastructure is another key part of an effective patch management process. The assessment should address such questions as:
Is a software distribution infrastructure in place?
Can it be used to distribute software updates?
Does it service all computers in your environment? Is it designed to handle patching of business-critical computers?
Is your SMS infrastructure properly maintained? More information about how to maintain your SMS infrastructure can be downloaded from http://www.microsoft.com/downloads/details.aspx?FamilyId=BD2B3619-4704-4C19-A00B-628E65F6F826&displaylang=en.

For more detailed information on SMS 2003 design considerations, please refer to the Microsoft Solutions for Management (MSM) Management Architecture Guide at http://www.microsoft.com/business/reducecosts/efficiency/manageability/default.mspx.

SMS site servers should be placed in locations that have a large client population or where there is a need to manage or control network bandwidth. The hierarchy might need to be deep (composed of many layers) to reflect the underlying network architecture or to allow for delegated administration.

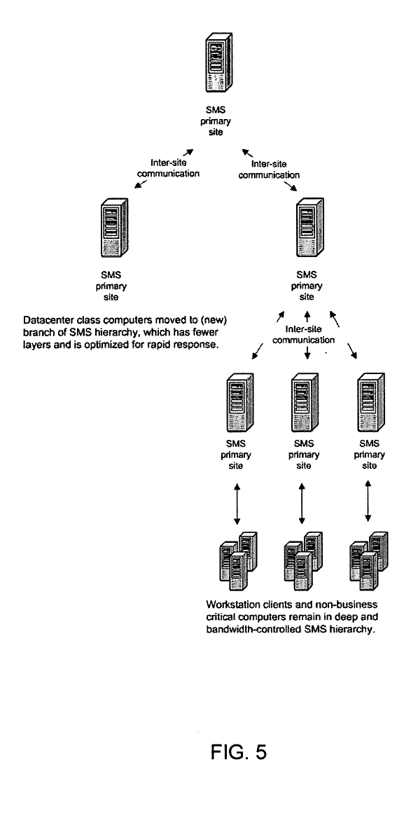

For business-critical servers, it is important to reduce the amount of time required to deploy software updates. Achieving this aim requires a flatter and more responsive SMS structure, as shown in FIG. 5. To create this structure, administrators must introduce new SMS site servers into locations with business-critical servers and ensure that these computers become clients of the new SMS site servers.
In some locations, there may be two SMS site servers—one that supports workstation clients and another that supports business-critical computers. Computers become clients of an SMS site only if their IP subnet matches the IP subnets that particular site manages.
To ensure rapid response times for SMS site servers supporting business-critical servers, administrators should not place any bandwidth restrictions on the intersite senders and should permit intersite communication to occur at any time of the day.

In the normal course of business, administrative and management functions should continue to be performed on the server at the top of the hierarchy. In the event that the organization needs to deploy a software update that addresses critical security vulnerabilities on data center servers, administrators should create an SMS package and advertisement at the SMS site server that is responsible for business-critical computers. Because the advertisement does not need to be passed through a deep SMS hierarchy to reach these computers, and because there are no bandwidth restrictions between SMS sites, the amount of time required for the software update to be installed should be significantly reduced.

Effective IT operational processes are perhaps the most important dependency for effective patch management. Microsoft Operations Framework (MOF), based on the IT Infrastructure Library (ITIL), details 20 service management functions (SMFs). Those SMFs that have direct impact on patch management include Change Management, Configuration Management, and Release Management. More information about the SMFs is available at http://www.microsoft.com/technet/treeview/default.asp?url=/technet/itsolutions/msm/default.a sp.

There are several questions to ask in assessing your operational effectiveness in the context of these SMFs:
Are there enough skilled people to perform patch management?
Are people aware that patch management is necessary?
Do those responsible understand security settings, common computer vulnerabilities, software distribution techniques, remote administration, and the patch management process?
Are there standard operational processes in place, or are day-to-day operations largely unstated and imprecise?
Do processes exist for change management and release management, even informal ones? Securing an environment from attack should not be left to chance or as-needed operations.
Is there an emergency process for deploying software updates?
Are processes continuously evaluated and tested?

Patch management is one of many areas of IT operations. Organizations spend a considerable percentage of their IT budgets on operations, because achieving operational excellence improves expenditures while improving mission-critical service reliability, availability, supportability, and manageability.

An operations assessment enables an operations staff to realize tangible benefits to existing or proposed operations, regardless of the size of the enterprise or its maturity level.

For a quick self-assessment of your organization's operational excellence, see the Microsoft Operations Framework Self-Assessment Tool at http://www.microsoft.com/technet/itsolutions/tandp/opex/moftool.asp.

To learn more about operations assessments and to find consulting services that can perform an operations assessment, see the MOF Operations Assessment Service Offering at http://www.microsoft.com/solutions/msm/evaluation/overview/opassessment.asp.

Administration Model

An organization should also review the current administration model of its IT environment and determine how well this supports patch management. Here are some of the issues that you need to consider:
How large is the infrastructure compared to the number of staff? What is the administrator-to-system ratio?
What is the current support model: centralized, decentralized, or shared?
What are the hours of operation for support staff? Are there sufficient change windows allotted for maintenance and administration?
Are roles clearly defined and communicated to team members?
Are service management processes formalized and being followed?
Are there sufficient tools for individuals to effectively execute their roles?

Skill Sets

The following questions may help to determine the appropriate skill sets required for effective patch management execution.
Do individuals have sufficient experience in handling the infrastructure size and complexity?
Were personnel trained correctly and with relevant technologies similar to what are deployed in production?
Are individuals working together synergistically as a team?
Do individuals have the appropriate experience or training to understand key operational disciplines and methodologies?
Do individuals have skills in scripting?
Do individuals understand user and system permissions and contexts?
Do individuals understand software update structures and dependencies?

Summary

The following are the key things to remember from the Assess phase of the patch management process:
You need to determine the threats to and vulnerabilities of your production environment.
You should understand what your business-critical assets are.
You should understand what you have deployed in your production environment and what is classed as managed (by management tools) and what is not.
You should ensure that your software distribution tools are configured, maintained, and able to support normal and emergency patch management.
You should ensure that your personnel have assigned roles and responsibilities and that they know how to respond in an emergency-that is, how to deal with the software update and how to mitigate its impact.

Handover to Identify Phase

The trigger for handover to the Identify phase of the patch management process is notification that a new software update exists.

Identify

Overview

The goal for the Identify phase is to:
Discover new software updates in a reliable way.
Determine whether software updates are relevant to your production environment.
Obtain software update source files and confirm that they are safe and will install successfully.
Determine whether the software update should be considered a normal change or an emergency one, and submit a request for change (RFC) to deploy it. Submitting an RFC is the trigger for the next patch management phase, which is Evaluate and Plan.

The remainder of this section will describe those goals in more detail. It will also address how you can meet these goals more quickly if you are dealing with an emergency.

Discover a New Software Update

Identification of a software update starts with discovering them in a safe and reliable way. Discovery has three main components:
How you are notified of a new software update
How you know you can trust the source and the notification
How you deal with dependencies

How You Are Notified of a New Software Update

Patch identification starts with patch notification, which should be supplied either through a subscription to a reliable source that provides scanning and reporting activities, or by some other reliable notification mechanism. The following are the most commonly used notification mechanisms:
E-mail notifications
Vulnerability scanning tools
The Systems Management Server (SMS) Software Update Management feature

E-Mail Notifications

Notification by e-mail is the most common form of patch notification. One option for e-mail notification is to subscribe to the Microsoft Security Notification Service at http://www.microsoft.com/technet/security/bulletin/notify.asp. For interim product releases, or software updates, you will normally be informed through an e-mail message that they are available on the Microsoft Web site.

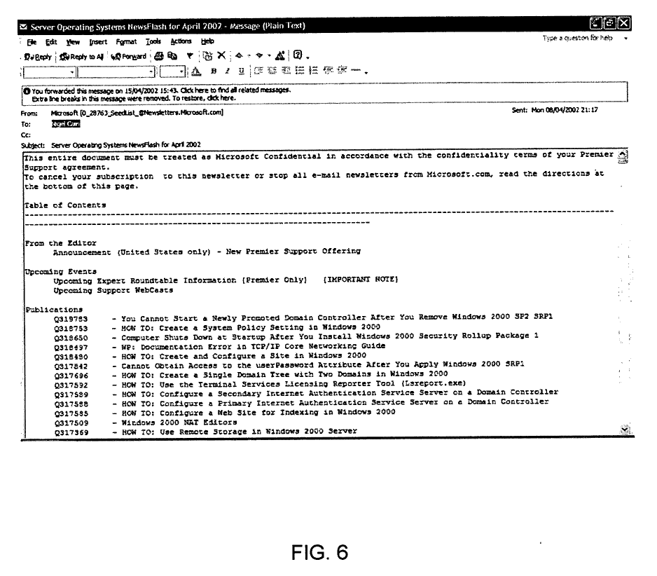

Upon subscribing to the Microsoft Security Notification Service—or other valid and monitored e-mail subscriptions—you will start to receive notifications about new software updates. FIG. 6 illustrates an example of an e-mail message notifying administrators of new security updates.

How You Know You Can Trust the Source and the Notification

It is important to handle e-mail notifications carefully. The following guidelines are designed to help you validate each notification and ensure it is the latest security bulletin information available:
Immediately delete any e-mail notifications claiming to be from Microsoft that contain any attached software files. Never run or install any executable attached to an e-mail notification.

Note Microsoft has a policy of never distributing software through e-mail attachments. Please review the Microsoft Policies on Software Distribution at http://www.microsoft.com/technet/security/policy/swdist.asp.
Do not click any links directly from inside an e-mail notification. Instead, you should paste any URLs into a browser window to confirm they direct you to a Microsoft Web site.
Always visit the Microsoft Security Web site to read the authoritative details of a security bulletin. Alternatively, if you don't expect to have Internet access when receiving bulletins, familiarize yourself with Pretty Good Privacy (PGP) encryption tools and use one to verify the authenticity of the PGP signature included on each security bulletin.
You can download the Microsoft Security Response Center (MSRC) Security Bulletin key from: http://www.microsoft.com/technet/security/MSRC.asc.
More information about how to verify the digital signature is available at http://www.microsoft.com/technet/security/bulletin/notify.asp.

Note There are several e-mail hoaxes that claim to be notifications from Microsoft. When you receive a Microsoft Security bulletin, confirm it and all hyperlinks to software updates by visiting the Security Bulletin Search Tool Web site at http://www.microsoft.com/technet/security/current.asp.

For more information about these types of hoaxes, see Information on Bogus Microsoft Security Bulletin E-mails at http://www.microsoft.com/technet/security/news/patch hoax.asp.

Although e-mail notifications include details on the vulnerabilities they report, you should always refer to the Microsoft Security Web site as the most comprehensive and up-to-date source of information on security bulletins at http://www.microsoft.com/technet/security/default.asp.

Will SMS Software Update Management Feature Detect the Software Update?

When you receive a new e-mail notification, you first need to determine whether the software update management tool within SMS 2003 will be able to detect that the software update is applicable to systems within your production environment.

The first step in determining this is to read Knowledge Base article 306460 at http://support.microsoft.com/default.aspx?scid=kb;en-us;306460 and check whether the software update can be detected as being installed or missing by MBSA. This will be indicated in the KB article.

If the product is in the supported list, then you need to check that the software update itself can be detected by MBSA. This is also indicated in KB 306460.

If the software update applies to a product that is not supported by MBSA or if it cannot be detected by MBSA, then you will need to use the information collected by SMS 2003 Hardware Inventory Client Agent and the SMS 2003 Software Inventory Client Agent to determine on which computers to apply the software update.

If the software update can be detected by MBSA, then you can use the software update management tools in SMS 2003 to identify computers on which the software update is applicable.

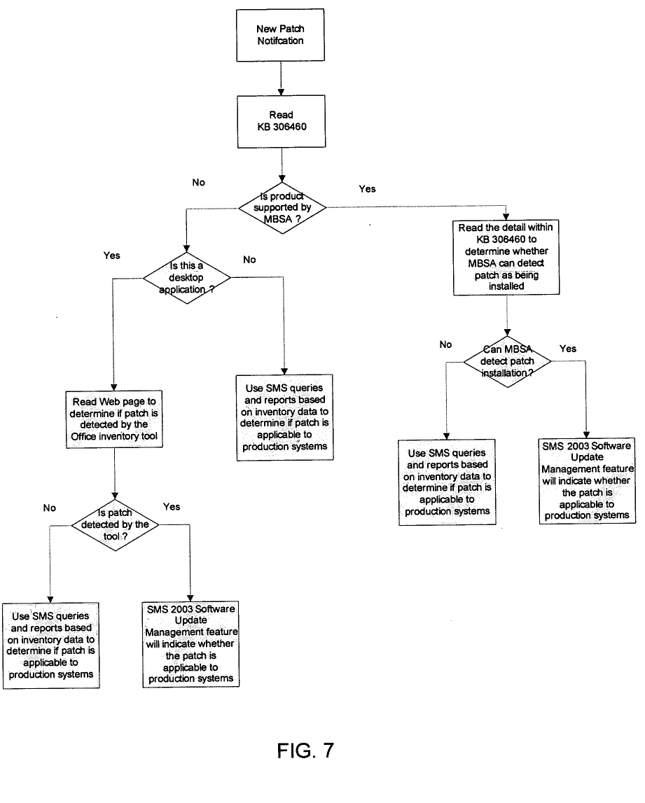

If the software update is for a Microsoft Office application, then you should check whether the software update is in the list of updates supplied by the Microsoft Office Inventory Tool for Updates. If the software update is included in this list, then you can use the software update management tools to determine to which computers the software update applies. Otherwise, you will need to create a report based on the information retrieved using the SMS 2003 software and hardware inventory client agents. FIG. 7 shows a decision-tree flow chart for identifying new software updates using MBSA.

Vulnerability Scanning Tools

Microsoft Baseline Security Analyzer (MBSA) is a useful tool for vulnerability scanning. You can use MBSA as a stand-alone tool to scan for missing and installed software updates on local and remote computers. MBSA can also scan all the computers in a given domain for missing and installed software updates. The results of these scans can be used to identify and discover missing software updates in your environment.

You can use components of the Software Update Management feature in SMS 2003 to scan for and report on missing and applied software updates across your environment. The Software Update Management feature consists of the following components:
Software update inventory tools
Distribute Software Updates Wizard
Software Updates Installation Agent
Reports

Of the above four components, you can use the software update inventory tools and SMS 2003 reports to scan for and report on installed and missing software updates.

The software update inventory tools are:
The Security Updates Inventory Tool, which handles security updates for Microsoft operating systems, Internet Explorer, SQL Server, and Exchange.
The Microsoft Office Inventory Tool for Updates, which handles software updates for Microsoft Office.

Those tools are not dependent on each other. You can use either tool without using the other, or you can use both.

Note Software update inventory tools are not installed on SMS sites by default. Instead, you must download them from http://www.microsoft.com/smserver/downloads.

The inventory data provided by the Security Updates Inventory Tool and the Microsoft Office Inventory Tool for Updates, provides detailed information in a central location about the compliance level of your SMS clients. This information includes:
A list of currently installed updates and service packs.
Software updates that are available and applicable.
The date and time the update was posted.
The date and time the update was installed (if applicable).

Additionally, the software update inventory data includes a link to Microsoft Knowledge Base articles on the applicable updates. This allows you to access relevant information to help you evaluate the need for these updates in your organization.

Each of the software update inventory tools consists of an installer program to install the tool.

Note For detailed technical information on the SMS 2003 Software Update Management feature and step-by-step instructions on how to carry out various software update tasks using SMS 2003, refer to: Chapter 6, “Managing Software Updates,” in the SMS 2003 Operations Guide and Chapter 3, “Understanding SMS Features,” in the SMS 2003 Concepts and Planning Guide, available at http://www.microsoft.com/smserver/default.asp.

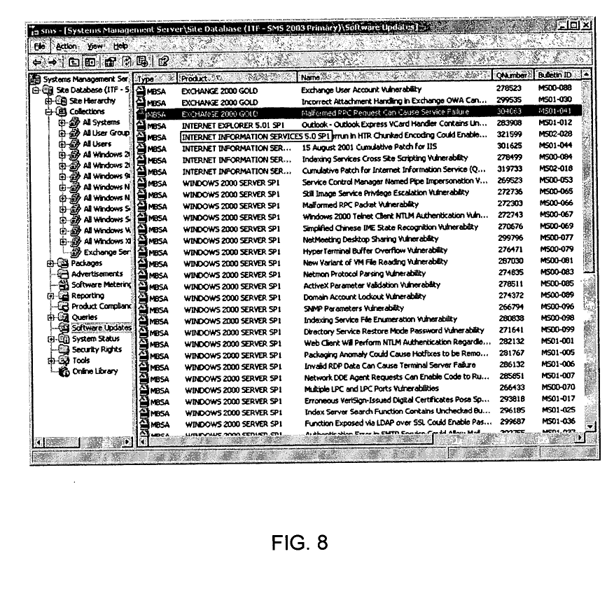

Running the software update inventory tools generates information both within the SMS Administrator console as well as a number of Web reports. FIG. 8 illustrates scan results of using the SMS Administrator console to identify missing software updates and associated bulletin ID numbers.

Microsoft releases information about security updates in the form of catalogs (Mssecure.xml) and Web downloads. The Security Patch Bulletin Catalog and the Microsoft Office Update Catalog are periodically updated as new security updates are released. The Software Update Management feature in SMS 2003 uses these catalogs as references to evaluate clients. Software update management tools perform a detailed inventory of the installed and applicable updates on all of the SMS client computers in your enterprise. Software update inventory tools scan clients and determine which updates are needed to bring the client up-to-date, and then administrators use the Distribute Software Updates Wizard to deploy necessary updates.

SMS 2003 includes several predefined update-related reports for discovering missing software updates throughout your organization. They display such information as applicable software updates and installation status.

As an example, you can use the Software updates with count of applicable and installed computers report in SMS 2003 to display a list of all installed or applicable software updates along with information about them. This report also lists the number of computers for which each software update is missing and the number of targeted computers on which the software update is already installed. FIG. 8 illustrates software updates with a count of applicable and installed computers Web report in SMS 2003.

You can also use the following sample SQL query to identify new software updates reported in the environment during the past seven days.

```
select QNumbers0 as Knowledgebase,
    ID0 as Bulletin,
    Product0 as ‘Affected Product’,
    Title0 as ‘Vulnerability’,
    MAX(DatePosted0) as ‘Release Date’,
    MAX(DateRevised0) as Revised,
    MIN(TimeDetected0) as ‘First Detected on Clients’
from v_gs_patchstate
where (TimeDetected0 >= DATEADD(day,−7,getdate( ))
or DatePosted0 >= DATEADD(day,−7,getdate( ))
or DateRevised0 >= DATEADD(day,−7,getdate( )))
  and Status0 != ‘Installed’
group by QNumbers0, ID0, Product0, Title0
```

Determine Whether Software Updates are Relevant

A large number of software updates are regularly released into the IT operations community. These come from a variety of sources and have been created for many reasons, including addressing problems that could lead to potential security breaches. All software updates must be checked thoroughly for their relevance to the IT infrastructure of the organization. The screening process outlined in this section should remove the majority of irrelevant software updates, but it is likely there will still be more that can be discounted.

Each software update received should be checked for relevance. When a notification contains information about more than one, each needs to be checked individually for its relevance to the organization.

The first step in checking for relevance is determining whether the software update is designed to address what you are running in your production environment—whether an operating system or applications.

Once you've determined that the software update applies to something in your production environment, the next question is whether the application or system has the vulnerability the software update is designed to address. For example, a security update might be designed for all Windows server operating systems running IIS with ASP enabled. While your environment might contain several Windows server operating systems, the security update does not have relevance if your organization does not have ASP enabled on any IIS servers.

Not every security update that applies to something in your environment will be relevant. Although it is important to be aware of and have a good understanding of existing security updates, deploying only those security updates that have relevance to your environment will minimize the effort that is required to keep your environment up-to-date and secure.

Although the information in a software update might be determined to be irrelevant, it is important to note that it exists by passing the information to personnel in problem management. If it later becomes relevant and is required, the organization will have access to this information at the original source.

Following are several screening methods you can use to determine the applicability of a software update to your IT infrastructure:
Reading security bulletins and KB articles
Reviewing the individual software updates
Using the SMS Administrator console
Using SMS built-in reports

Reading Security Bulletins and KB Articles

Information in security bulletins on the Microsoft Web site is arranged into sections that help you determine how critical the described vulnerabilities are to your environment. Although you should review all information in a security bulletin, pay close attention to the following sections listed in Table 1 below when you first examine a security bulletin.

TABLE 1

| Section | Description |
|---|---|
| Summary | Immediately review the Summary section of a security |
| | bulletin. The Maximum Severity Rating, Impact of |
| | Vulnerability, Affected Software, and Recommendation |
| | items contain information that will assist you with |
| | determining how susceptible your environment is to the |
| | vulnerability. |
| Technical | The Technical Details section provides an in-depth |
| Details | technical description of the vulnerabilities. This section |
| | also outlines the mitigating factors and the severity |
| | of the vulnerability for all affected products. |
| Work- | The Workarounds section includes information on the |
| arounds | workarounds that Microsoft has tested in order to help |
| | mitigate the threat until you have patched your |
| | environment. You must read this section as part of |
| | your risk assessment. |
| Frequently | The Frequently Asked Questions section provides answers |
| Asked | to commonly asked questions specific to that vulnerability |
| Questions | or fix. This is a good place to start after reading the |
| | Summary section. |
| Security | This section lists items like Prerequisites, platform-specific |
| Patch | Installation Information, Deployment Information, Restart |
| Information | Information, Removal Information, File Information |
| | including file names, size, versions, target folder, and Patch |
| | Verification steps. |
| Knowledge | Refer to the Knowledge Base (KB) article identified in the |
| Base article | title of a security bulletin. Additional information on the |
| | vulnerabilities and any updates prescribed by the security |
| | bulletin is provided in the KB article. The number in |
| | parentheses to the right of a security bulletin's title indicates |
| | the security bulletin's corresponding KB article. Use this |
| | number to search for the article on the Microsoft support |
| | Web site at http://www.support.microsoft.com. |

For more information on the security bulletin release process, see the Revamping the Security Bulletin Release white paper at http://www.microsoft.com/technet/security/bulletin/revsbwp.asp.

The information gathered in the initial notification and the further information discovered by reading the security bulletin and associated KB article will help you to decide whether the software update has relevance to your organization.

The brief descriptions in the summary section of a security bulletin should enable you to make a quick assessment of the potential impact the vulnerability might pose to your environment without having to closely review the entire contents of a bulletin. The summary highlights the type of exploit, provides a list of the affected software, and recommends the proper course of action. After reviewing the summary section, you should be able to determine if you need to immediately perform an in-depth review of the remaining sections of the security bulletin.

Using high-level relevancy checks, you should be able to isolate the computers in your environment likely to be affected by the vulnerability. Do this by reviewing the affected products listed in the bulletin and by accessing the inventory data available in SMS.

For example, SMS 2003 provides default collections for the following products:
Windows 2000 Professional
Windows 2000 Server
Windows XP
Windows 98
Windows NT 4.0
Windows Server 2003

In addition to the items described above, the Microsoft Security Response Center (MSRC) has implemented the Maximum Severity Rating System to assist you with quickly determining how important an update is to your organization. These ratings are based on the potential impact of the vulnerability and are intended to inform you of the urgency of any required actions.

Determining the relevance of technology-specific software updates can pose significant challenges to any environment. Technologies, such as the Microsoft Data Engine (MSDE) or Microsoft Internet Information Services (IIS), which can be installed on clients or servers, can make it difficult to determine if a software update is relevant to any specific subset of computers in your environment. This emphasizes the importance of maintaining as accurate an inventory of your environment as possible.

Reviewing Individual Software Updates

Each software update in a notification requires a detailed and in-depth review. This review should include all associated documentation, including that sent with the software update, and supporting information that might be found, for example, on Microsoft's TechNet Web site.

Once you receive an e-mail message identifying applicable software updates, you need to make someone responsible for investigating them. This team member should then take ownership of the software update. The reviewer needs to read the relevant Knowledge Base article and understand what the software update fixes.

The software update might be only specific for particular scenarios or configurations. The reviewer should check whether the scenario/configuration deployed in production matches the Knowledge Base article. It might be necessary to build SMS queries and Web reports to obtain this information.

For example, if the Knowledge Base article states that the software update is required only for computers (with more then 3 gigabytes of memory) running SQL Server, the reviewer may need to create a query or Web report to determine whether any computers running SQL Server have this configuration. Security updates, however, might need to be applied in a preventative manner before any such symptoms appear.

There are also questions to ask in terms of software update dependencies:
Are there dependencies relating to the update? For example, do certain features need to be enabled or disabled for the update to be effective?
Does the software update require a certain service pack to be installed? Is the software update superseded by a service pack or another software update and does it makes sense to wait for a newer version?

Identifying the above dependencies is critical because it will have a direct impact on your release and deployment planning for the software update. Document which service pack the software update will appear in and whether a different version of the software update is needed, depending upon the active service pack. (This is important to know in case compliance problems occur as users upgrade from one service pack to another.)

Using the SMS Software Update Management Feature

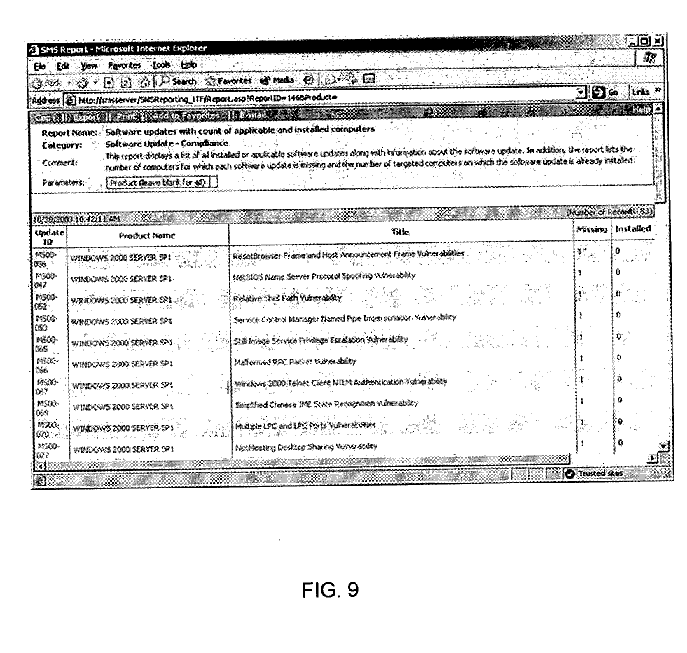

You can use the scan results and reports generated by the SMS 2003 Software Update Management features to view the specific and applicable information regarding a software update. FIG. 9 shows a highlighted security patch associated with Exchange 2000. The value under the Requested column shows the number of computers that have requested this update in your environment. The value under the Compliant column shows the number of computers that already have the update installed in your environment and are compliant. For example, FIG. 9, only one computer has requested the Exchange 2000 update.

Using SMS Reports

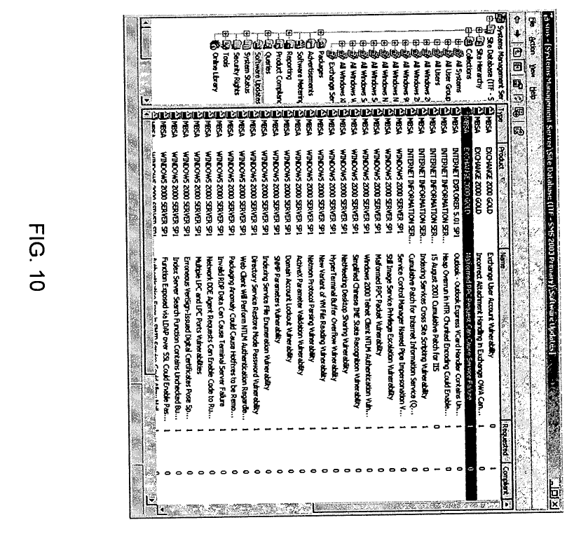

The Compliance by Software ID report in SMS provides a summary of the total number of computers on which the security update has been installed—and those on which it has not been installed—as well as the status relating to security patch distribution. This report, as shown in FIG. 10, helps identify the current compliance levels for a particular security update (in this case, 311967) and is a useful tool in determining the applicability of a specific security update for your environment.

Note An interesting feature of the reports provided by SMS 2003 is that you can view the SQL query behind each of these reports and copy and modify the query to customize the reports. This feature also allows you to refresh a report automatically from every 1 minute to every 60 minutes. This feature is especially useful during an emergency—where you are constantly looking to update the status and reporting of software update distribution and compliance levels for a specific software update. In order to use this feature, just select/highlight a specific report and view its properties.

Deciding When to Apply the Software Update

The next relevance issue to consider is whether an otherwise applicable and relevant software update needs to be applied right away. In some cases, software updates must be applied immediately. For example, you might need to apply a software update immediately when security issues are involved, virus protection needs to be updated, or a problem or incident needs to be resolved. Conversely, you might consider applying a security update proactively for the same reasons—for security preparedness, to ensure that virus protection is current, or to deal with incidents or problems reported by other organizations.

If administrators determine that they do not need to apply a software update immediately, they need to make problem management personnel aware of the software update and its supporting information, including details of any potential issues that might affect the IT infrastructure and any fixes that may be available.

When the appropriate technology stream has determined that a software update is relevant to the organization and might need to be applied and the supporting documentation has been checked, the next step is to validate or verify the software update itself. The next section describes some key guidelines that help in validating the software update.

Obtain and Verify Software Update Source Files

Once a software update has been identified and its relevance established, you need to obtain the software update source files and confirm that they are safe and will install successfully. The verification process will either authenticate security updates or highlight updates that are not security-validated. In the latter case, when an invalid notification is received, information about the notification should be sent to those responsible for the subscription process and to the security team for further investigation. For example, if a notification comes from a normally reliable source of information, but the specific notification has errors on validation, this might raise security concerns about the quality of the notifications from this particular source. The source should be investigated and any issues resolved.

At a minimum, your software update verification should consist of the following steps:
Identifying and verifying the software update owner
Reviewing all accompanying documentation
Reviewing the software update files
Identifying the software update size
Identifying the software update dependencies
Identifying any pre- or post-software updating actions needed
Verifying that the software update install procedures exist
Verifying that the software update uninstall procedures exist
Ensuring that the software update is free from viruses

Identifying and Verifying the Software Update

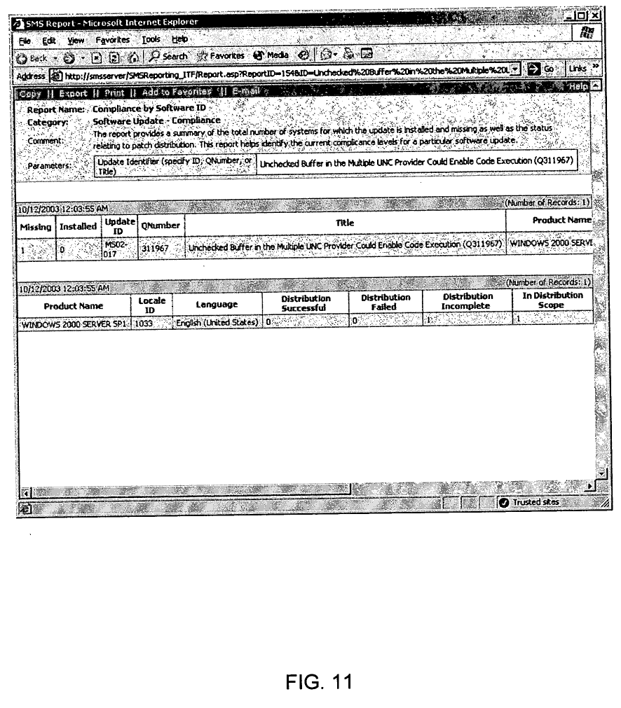

Software update validity should not be taken at face value because there are many malicious sources that might send a virus disguised as a software update or security notification. All Microsoft security updates will be signed, as shown in FIG. 11.

Microsoft will notify administrators of new software updates through e-mail messages, but it will never include (or attach) software files to these messages. The way Microsoft notifies its customers of new security updates is described in the article found at http://www.microsoft.com/technet/security/policy/swdist.asp.

Reviewing All Accompanying Documentation

Before applying any software update, you should read and peer review all relevant documentation. The peer-review process is critical as it mitigates the risk of a single person missing critical and relevant points when evaluating the update. As you read the documentation, look for answers to the following questions:
Will adopting the update cause other problems, resulting in a compromise of the production system?
Do you need to perform any actions prior to deploying the update?
Do you need to perform any actions after deploying the updates?
Are there workarounds or mitigation steps available while you patch your environment?
Are software update install procedures available?
Are software update uninstall procedures available?
What is the software update file size? File size will impact your overall release process and plan—for example, how you handle mobile users.

Information is available in the security bulletin under the sections described earlier in this document that will help you find answers to the above questions.

Ensuring That the Software Update is Safe

To prevent virus infection or malicious code from affecting your IT infrastructure, you should look at any files related to a software update in an isolated (quarantined) environment. This quarantine should be imposed on all software and documentation. There should be strict controls in place in the quarantined environment and, to ensure this, the quarantine process should be carried out by a specialist group within the organization.

On rare occasions, software updates will only require you to make registry or configuration file changes or adjust application settings, but most software updates will involve downloading files. Always quarantine the files that you download by isolating them from your production network while you examine them for viruses and confirm their digital authenticity.

Note The Microsoft Download Center, Windows Update (and the Windows Update Catalog), SUS, and SMS 2003 with Software Update Management features provide only authentic, Microsoft software updates. If you receive a Microsoft software update through any other means, be sure to confirm its validity and digital signature.

Verifying the Software Update Install Procedures

The following are some guidelines for verifying the software update install procedures:
Follow the instructions given in the Knowledge Base articles and the security bulletin accompanying a software update to verify that it installs correctly.
Understand whether the software update requires a restart. If it requires a restart, you will have to take into account special considerations during the planning and deployment phases for mission-critical servers, core infrastructure servers, and servers running line-of-business applications. These considerations are given in the Evaluate and Plan section later in this chapter.
Know how much space it takes up (including an uninstall folder).
Understand what configuration options are available to you during the install.
Read any supporting documentation for additional information about installing a software update and evaluate the pros and cons of applying it.

It is possible that despite your testing, you will run into problems after installing the software update that require you to uninstall it. It is important, therefore, to test that the uninstall works. After uninstalling, you should check that the server continues to run as expected and continue to watch the Event Log and System Monitor counters.

Some of the updates released by Microsoft provide an uninstall path, whereas others do not. You will have to determine which software updates can be uninstalled by reviewing the technical details of the security bulletin under the Security Update Information section.

Decide Nature of Software Update and Submit RFC

Now that you have identified the software update and determined its relevance to your organization, the next step is to submit a change request to start the evaluation and planning phase.

In the case of an emergency, a number of these activities will be performed during a much shorter timeframe, based on the SLAs set by your organization. An example rapid deployment process with timelines is shown in Appendix E, “Rapid Deployment Procedure.” You will need to customize this process to the specific needs of your organization.

The change request submitted must address the following information:
What is the change?
What vulnerability is the change in response to?
What services will be impacted by the change?
Is a software update already being deployed for that service?
Does the software update require a restart to complete the installation?
Can the software update be uninstalled?
What, if any, countermeasures can you implement to give you more time to test and deploy the software update?
What are the recommended test strategies for this change?
What is the suggested priority of the RFC?
What is the impact (category) of the change?

Summary

The following are the key things to remember from the Identify phase:
You need to ensure that you are notified of all new software updates.
You should confirm that the software update notification comes from an authorized source.
You should check that the software update is relevant to systems within your production environment.
You need to obtain the software update source files and confirm that they are virus free.
You need to check that the software update installs successfully.
You need to decide whether the software update is an emergency and submit an RFC to deploy it into production.

Handover to the Evaluate and Plan Phase

You have completed the requirements of the Identify phase and are ready to proceed to the Evaluate and Plan phase when:
You have verified that you have a relevant software update that is safe to deploy.
You have submitted a request for change (RFC), which is the trigger for the Evaluate and Plan phase.

Evaluate and Plan

Overview

The third major step in the patch management process is evaluating the software update and—assuming that it is approved for deployment—planning for its deployment into the production environment.

The entry point to the evaluation and planning process is an RFC for a software update that has been identified as relevant to your production environment.

By the end of the Evaluate and Plan phase, you should have determined whether the change request should be classified as an emergency, reviewed and approved the request, and determined the tasks necessary to deploy the approved changes into production. You should also have tested the software update in a production-like environment to confirm that it does not compromise business-critical systems and applications.

The remainder of this section will focus on the key requirements for evaluation and planning. Those requirements are:
Determine the appropriate response
Plan the release of the software update
Build the release
Conduct acceptance testing of the release

Determine the Appropriate Response

The RFC determines the sort of change required in the production environment—for example, deploying a software update, applying countermeasures that mitigate a vulnerability, or both—and describes the required change so others can act on it.

The first step in evaluating and planning is to review the RFC and determine the most appropriate response to a software vulnerability or threat. This will involve:
Prioritizing and categorizing the request.
Obtaining authorization to deploy the software update.

Prioritizing and Categorizing a Software Update

Before a software update can be authorized, its priority and category need to be determined. Although priority and category are initially assigned by the change initiator and included in the RFC, those assignments have to be reviewed and agreed to or changed before the change request can be authorized.

Prioritizing a Software Update

The level of priority is particularly important because it determines how quickly a software update passes through the change process. The following are considerations for determining the priority level of a software update:
What are the critical business assets and will these be exposed to a potential security breach or system instability until the software update is installed? You should prioritize change requests based on the impact of patching or not patching high-value assets.
If a software update applies to a system running a business-critical service—such as a line-of-business application—that has been the target of attackers in the past, this can be a good reason to raise the priority of the change request.
If you have deployed countermeasures that minimize exposure to a particular security vulnerability, this can lower the priority of the change request. Although the priority of the request is lower, it may still be appropriate to deploy the software update into production to eliminate the vulnerability.
What is the threat of the vulnerability in question to the production environment? Many security bulletins and related software updates might apply to only a few computers in your environment. If the threat of the vulnerability is low, that might lower the priority of the request.

Tables 2 and 3 can help in assessing the priority of the request in relation to other requests. The first table maps priority levels to recommended time frames and minimum recommended time frames.

TABLE 2

| | | Minimum |
|---|---|---|
| | | Recommended Time |
| Priority | Recommended Time Frame | Frame |
| Emergency | Within 24 hours | Within 2 weeks |
| High | Within 1 month | Within 2 months |
| Medium | Depending on availability, | Deploy the software |
| | deploy a new service pack or | update within 6 months |
| | update rollup that includes a fix | |
| | for this vulnerability within 4 | |
| | months. | |
| Low | Depending on availability, | Deploy the software |
| | deploy a new service pack or | update within 1 year, or |
| | update rollup that includes a fix | you may choose not to |
| | for this vulnerability within 1 | deploy at all. |
| | year. | |

The Table 3 offers examples of factors that might raise or lower the priority.

TABLE 3

| | Priority |
|---|---|
| Environmental/Organizational Factor | Adjustment |
| High-value or high-exposure assets impacted | Raise |
| Assets historically targeted by attackers | Raise |
| Mitigating factors in place, such as countermeasures that | Lower |
| minimize the threat | |
| Low-value or low-exposure assets impacted | Lower |

Emergency Change Request

If the vulnerability that the security update addresses is already being exploited or is about to be exploited, or if the update corrects a system instability being encountered in the production environment, then you might need to classify the request as an emergency and give this request priority over all other changes happening within the production environment.

Categorizing an Software Update

The category of a software update is important because it helps those reviewing the change to understand the impact it will have on systems and services within the production environment. To establish the category (or impact) of the change request, you will need to determine:
Which machines the software update needs to be installed on and the roles (business criticality) of those machines. A software update that requires a business-critical computer to be rebooted, for example, will have a greater impact than one that does not.
If additional changes will be needed to support the deployment of the software update. If, for example, the software update applies only to the current service pack—and if the service pack is not installed on certain production systems—it may not be possible to protect those systems against a particular security vulnerability. The impact, and hence the category, of the change request will be greater because both the service pack and the software update need to be deployed.
If the software update cannot be uninstalled once it has been installed, it presents a greater risk to the production environment than one that can be successfully removed. Although it may be necessary to deploy these software updates to provide protection from a particular security vulnerability or to address a particular system instability, the category of the request needs to reflect this.
What is the network infrastructure impact? Deploying a large software update to many computers simultaneously could degrade network performance and adversely affect the proper operation of your entire environment. Closely review all software update documentation, and always be aware of the software update's size and the number of computers that will receive it. This information can assist with properly scheduling the release.
Do certain services need to be stopped, paused, or closed during installation? This may have an effect on an organization's critical services or prevent an end user from working on the computer while the installation is taking place.

Obtaining Authorization to Deploy the Software Update

Once the change request has been prioritized and categorized, it needs to be reviewed and authorized before the software update can be deployed into production. To get the change request authorized, you need to:
Determine who should be involved in the decision-making process.
Review the change request, assess the risks and consequences of deploying the software update, and select the most appropriate course of action.
Identify who will be responsible for getting the software update deployed to all impacted systems.

Determining Who Needs to Be Involved

It is important to determine who should be involved in reviewing and authorizing a software update for deployment into production. For non-emergency updates, review and authorization will be done by a change advisory board (CAB), which should be made up of representatives from areas of the business that will be impacted.

CAB members should include individuals who have experience in the specific technologies and services that will be used to deploy the update. Representatives from the business, network, security, service desk, and technical support teams should also be included in this group.

More information about CABs and how they can be formed can be found in the Change Management SMF.

Emergency Change Request

When a quick decision needs to be made about a critical request—one designed to close a security vulnerability or avoid a critical system failure-authorization should be done by the CAB emergency committee (CAB/EC).

A CAB/EC should be composed of people who possess the authority to approve emergency changes and who will be available to make quick decisions. More information about CAB/ECs can be found in the Change Management SMF.

Review Change Request

Once the appropriate people are assembled, they need to assess the risks and impact of the software update to the production environment and determine whether it should be deployed. In making this decision, the following issues will need to be discussed:
What else is happening in the production environment?
What is the impact of applying or not applying a software update?
What is the anticipated cost of deploying or not deploying the software update?
What are the steps that can be taken—if any—to mitigate the exposure to a security vulnerability or system instability while the software update is being deployed?
What is the impact of computer downtime? It will be necessary to compare and consider the risks of postponing the deployment of a software update versus the risks incurred by causing computer downtime when deploying a software update to your environment.
What will be the best and most effective mechanism for deploying the software update?
Are there any known issues or side effects with the software update, and does the software update necessitate a system restart?
Are enough resources available to deploy the software update or deal with any issues experienced during deployment?
How will you address any dependencies or prerequisites that need to be met before the software update can be deployed?

Although the best response to software vulnerability will be to deploy the software update that resolves the issue, sometimes it may be preferable to deploy a short-term countermeasure—such as closing network ports or shutting down external access to systems—while the software update is being rolled out to systems within the production environment. Applying countermeasures may have several benefits:
The majority of software updates require that target computers be restarted before the installation is complete and the computer is safeguarded. If you are prevented from immediately deploying a software update to your environment because computer restarts are limited to specific maintenance windows, implementing recommended countermeasures can effectively safeguard your computers until the software update can be deployed.
Countermeasures may be of lower risk and can be applied more quickly and with less testing than the software update itself. It may be significantly easier, for example, to disable network ports or to shut down services or systems that are exposed to a particular security vulnerability and apply the software update later.

Implementing computer hardening countermeasures can often protect computers from many common security vulnerabilities. Blocking certain network ports and disabling unused services are some of the countermeasures that, when implemented, can effectively safeguard your computers. For more information on computer hardening countermeasures, see: http://www.microsoft.com/downloads/details.aspx?displaylang=en&familyid=1b6acf93-147a-4481-9346-f93a4081eea8

Note It is important to note that even if countermeasures are deployed to reduce the exposure to a security vulnerability, the security update should still be scheduled for deployment.

For example, if systems remain unpatched and a computer infected with a worm/virus is introduced to the network, the infection will quickly spread to all unprotected systems. The deployment of countermeasures should simply lower the priority of the change request rather than remove the requirement for the software update.

Decide Who Will Own Deployment of the Software Update

Once agreement has been reached to deploy the software update and use any countermeasures (if appropriate), you need to identify who will take responsibility for making sure that these changes happen. This person will need to:
Develop a plan for making the required changes.
Determine and obtain the resources required.
Arrange for the development of any necessary scripts, tools, and documentation that will be necessary to deploy the changes.
Ensure that adequate testing is carried out.
Ensure that the changes are deployed into production.
Assess the success or failure of deployment.

Without a designated owner to oversee the above activities, there is a risk the software update might not be deployed. (The designated owner is typically the Release Manager role referred to in the Release Management SMF.

Plan the Release

Release planning is the process of working out how you will release the update or security update into the production environment. The following are the major considerations for planning the release of a new software update:
Determining what needs to be patched.
Identifying the key issues and constraints.
Building the release plan.

Determining What Will Be Patched

Deciding what needs to be patched requires an accurate and up-to-date knowledge of what is present in the environment. Information retrieved by the Security Updates Inventory Tool and the Microsoft Office Inventory Tool for Updates, together with that retrieved by the SMS hardware and software inventory client agents, can be used to determine the machines on which a particular software update needs to be installed. It is also important to determine the type and role of the machines that are to be patched and their connectivity to the network.

Emergency Change Request

For critical updates, you need to determine—as accurately as possible—the number and type of systems that are at risk. To obtain inventory data more quickly than the regularly scheduled inventory cycle, the SMS administrator will need to create a mandatory advertisement to run the Security Updates Inventory Tool or the Microsoft Office Inventory Tool for Updates that forces hardware and software inventory to run on each client computer perceived to be exposed to the vulnerability.

Identifying the Key Issues and Constraints

There may be a number of issues and constraints that dictate the steps necessary to fully deploy the software update into production. For example, the team tasked with deploying the software update may need to consider the following:
How much time should you give users before the software update is installed automatically? The amount of time permitted will depend on a number of factors, including user roles and responsibilities and the nature of the system instability or security vulnerability that the software update is designed to address.

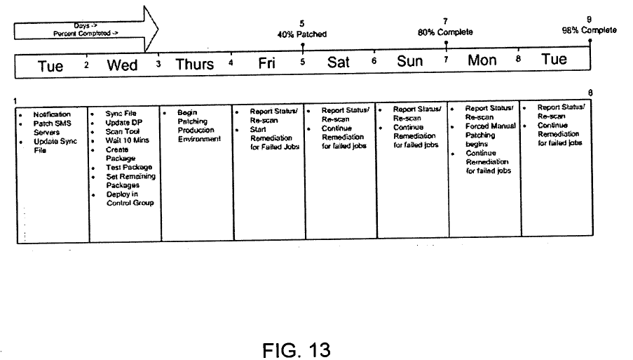

FIG. 13 shows an example software update deployment timeline (SLA) that indicates that servers must be patched within seven days of the arrival of a software update that is not deemed business critical. Administrators are granted permission to start patching within the seven-day window, but need to be aware that computers will be force-patched or disconnected from the network after the time period expires. The required response time and actions taken when computers are not patched within the allotted time frame may be different for your organization.

A similar compliance timeline may be applied to workstations in your environment.
Certain software updates require administrative rights on the computer they are being installed on. Most end users will not have local administrator rights and the tool used to install the software update will need to be able to acquire elevated rights and privileges to install the software update on client computers.
If the software update requires a certain amount of disk space to install or the software update is to be cached locally prior to installation, then a check needs to be made on the amount of free disk space on each client computer.
If the software update is large—for example, in the order of several megabytes—mobile clients may take some time to download it. If the software update is not classified as an emergency, it may be appropriate to postpone installation on those clients until they are physically connected to the network.
Business-critical computers may have specific times at which changes and computer restarts are permitted (outage windows). The deployment of a software update and any system restarts that are required as a result will need to be scheduled within these outage windows.
If client computers are locked down through the use of certain Group Policy settings, this may affect the software update's ability to install correctly.
If the product to be patched was deployed using Windows Installer, the Windows Installer may require access to original installation files. These files need to be in the same location as they were when the product was originally installed if you are performing an unattended installation of the software update. If the product was installed from physical media such as a CD drive, for example, Windows Installer will try to find the original files on the currently inserted CD.
If an administrative image was used for the original installation of a Microsoft Office product, you will need to perform an administrative installation of the software update to the image rather than apply it directly to the client. More information on the issues around patching an administrative image is available at http://www.microsoft.com/technet/treeview/default.asp?url=/technet/prodtechnol/sms/deploy/d epopt/smsoffxp.asp.
If there are applications that were installed on a per-user basis rather than a per-computer basis for all users, you should reinstall the application on a per-computer basis and then apply the software update to the new installation.
There can be issues with trying to deploy large software updates to mobile clients that connect to the network through slow and intermittent dial-up links. It can take a long time (up to several hours) to complete installation if it is attempted across a dial-up link.

Emergency Change Request

If the change request indicates that the software update is regarded as an emergency, the following factors need to be considered:
The software update may need to be deployed in a significantly shorter time span than normal. Full deployment, for example, may be expected within 24 hours of the approval of the change request.

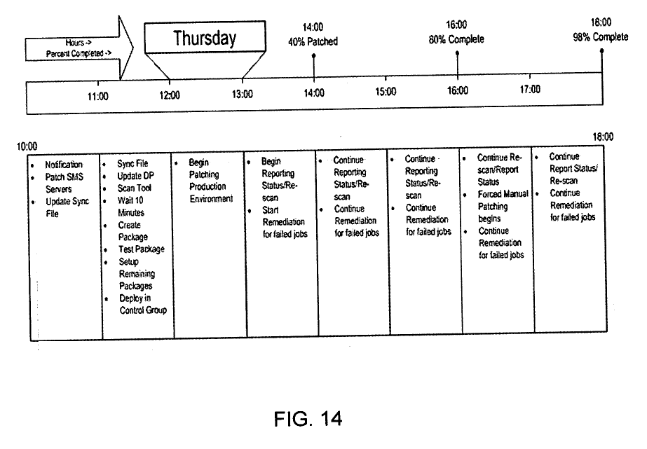

FIG. 14 illustrates an example deployment timeline (SLA) that indicates that all servers must be patched within eight hours the organization being made aware of a software update considered to be business critical. The time window and speed of response may be different for your organization.

In the example above, once the organization has been made aware of the software update, patching of business-critical servers must begin within two hours (12:00 as shown) with 98 percent of all servers brought into compliance by 18:00. The remaining servers need to be brought into compliance by 22:00 or risk being disconnected from the network. A similar compliance timeline may be enforced for workstations in your environment.
SMS intersite senders must be configured to allow high-priority package/advertisement transactions to replicate at all hours of the day. The high-priority setting should be allocated only to packages and advertisements for software update content.
The outage windows that govern when certain business-critical systems can be patched or restarted will need to be overridden to allow the software update to be deployed within the agreed-to time frame.
The software update will need to be applied to all affected systems, regardless of their connection to the network.

Building a Release Plan

This is the point at which you will need to plan and determine the order in which the computers within your production environment will deploy the software update. The following are some of the issues you may need to consider when building the release plan:
If the software update applies to all servers within the production environment, should those running SMS and monitoring tools be patched first? Patching the management infrastructure first ensures that administrators can use these services to monitor the progress of the deployment.
Are there any business reasons why one part of the production environment should be patched before another? There may be compelling reasons to apply the software update to computers that are at risk from a security vulnerability or potential system instability and then, once these computers are patched, continue the rollout elsewhere.
The available network bandwidth between sites will also have an impact on the rollout order. It may be difficult to get the software update out to some sites as quickly as others because of network bandwidth constraints; the software update can be deployed to sites with good network connectivity much more quickly than those where network availability is limited.
You will need to determine how and when information about the software update, its severity, impact, and the steps that need to be taken to deploy it, will be communicated to users, the business, and the service desk.

Emergency Change Request
If management architecture components such as MOM and SMS 2003 site servers also need to be patched, it may be appropriate to plan to have these computers patched manually—by local administrators—to ensure that these servers are not restarted during the rollout of the software update to other computers within the production environment.
If one site or group of computers has already suffered from a security breach or system instability that the software update addresses, deployment of the software update should be directed to those computers first.
For sites with poor network connectivity, it may be necessary to plan for the use of the SMS Courier Sender to place the software update files on removable media and for this media to be transported to those sites as quickly as possible.

See Appendix E, “Rapid Deployment Procedure,” for more details of the technical steps and activities that need to be included in the release plan for an emergency change request.

Build the Release

With a release plan in place, the next stage of the process is to develop the scripts, tools, and procedures administrators will use to deploy the software update into the production environment. The tasks and activities that need to be carried out here will depend, primarily, on whether the software update can be deployed using the SMS 2003 Distribute Software Updates Wizard.

The Distribute Software Updates Wizard eliminates much of the work that would traditionally be required to deploy a software update using SMS 2003, because it can automatically create the SMS package and program required to distribute and install the software update. Security updates that are not part of an emergency change request can be added to a security rollup package that includes all security updates that apply to a specific product and service pack combination. All of the security updates that apply to Windows 2000 SP3, for example, can be included in a security rollup package that will apply the applicable security updates to a computer and restart the computer only once. The use of security rollup packages can greatly simplify management and administration as well as significantly reduce the number of computer restarts required to bring a computer into compliance.

For software updates that cannot be deployed using this feature, administrators should use the standard software distribution procedures in SMS to create a package and advertisement to deploy the software update. It will also be necessary to specify the batch file, MSI file, or an executable that will be run on the client computer. If the software update is not supplied with a setup executable, administrators will need to build one using MSI authoring tools.

The following are further considerations for building the release:
Any program that is developed to install the software update should return the correct exit code so that the correct status is returned by means of the SMS status system. This should be zero for a successful installation and any number other than zero should the installation fail. The return code is used by the SMS status system to indicate successful or failed advertisements.
It may also be necessary to ensure that the program inserts a custom key into the system registry so that administrators can determine the presence of the software update on a particular computer. The SMS Hardware Inventory Client Agent will need to be configured to collect this information from the SMS client before it will appear in the SMS database and can be used in Web reports and queries.
The program or batch file must not exit until installation is complete. SMS 2003 assumes that an advertisement has been run to completion when the program associated with that advertisement exits. If the program spawns another process and then exits before the new process has completed installation of the software update, the program will be unable to return an exit code appropriate to the success of the installation.
The batch file or program should be configured to write an event to the Event Log should the installation fail. To alert administrators to the failure, you will need to create a corresponding rule in Microsoft Operations Manager (MOM) that will generate an alert for that event.

You might also want to further develop the script so that it writes an event to indicate that patching is in progress. This will prevent spurious alerts in the MOM console when the server is restarted.

Emergency Change Request

For those software updates that are supported by the Distribute Software Updates Wizard, administrators should use this tool to create a new SMS package and advertisement to deploy the software update. They should also add the software update to the security rollup package mentioned earlier. Once the software update has been successfully deployed to all clients within the production environment, the separate package and advertisement for the software update can be retired. The security rollup package will ensure that the software update is applied to any new computer introduced into the production environment.

For software updates that cannot be deployed using this feature, you will need to create an SMS package and advertisement to deploy the software update. If the software update is not supplied with a setup executable, administrators will need to build one as described above.

Acceptance Testing

Up to this point, the purpose of testing has been to confirm that the software update and the release package work correctly within a development environment.

Acceptance testing allows developers and business representatives to check that updates work in an environment that closely mirrors production and that business-critical systems continue to run successfully once the software update has been deployed. Administrators, together with business representatives, should draw up a set of tests that will be performed when a software update is regarded as business critical, and a more detailed set of tests that can be used when the software update has a lower priority.

The following tests should be carried out as a minimum, whether the software update is regarded as normal or business critical. The test results should show:
That once installation is complete, the computer should reboot as it is designed to.
That the software update, if it is targeted at computers connected across slow/unreliable network connections, can be downloaded across these links and, once this completes, that the software update successfully installs.
That the software update is supplied with an uninstall routine, and that this can be used to successfully remove the software update.
That business-critical systems and services continue to run once the software update has been installed.

It is important to collect information about troubleshooting steps, procedures, and tools used during testing and to make these available to service desk support staff and the operations team before you deploy the software update into production.

You should expect that testing will result in the creation of:
Internal Knowledge Base articles describing standard troubleshooting steps with associated workarounds, if any.
A list of contacts and an escalation path.
Information—such as counters, events, and thresholds—and scripts and rules that will enable your operations staff to effectively monitor the release in production.

No matter how much testing is performed, rolling out a software update into production often produces effects that can never be anticipated or replicated in a lab environment. To avoid impacting a large number of client computers with a potential failure, administrators should consider rolling out the software update into a small representative sample of computers and confirming that business-critical systems and applications continue to run before deploying it to the entire organization.

Appendix F, “Building a List of Reference Computers,” provides a sample script to create a collection containing all representative computers in the environment.

Summary

The following are the key things to remember from the Evaluate and Plan phase:
You need a formal process to determine whether it is in the best interests of the business to deploy the software update.
You need to have an identified owner of the software update who will be responsible for ensuring that it is deployed.
When you have an approved software update, you need to plan how to get it into production.
If one is needed, you will need to build a package that will deploy the software update.
You need to test the package in a lab and, if needed, pilot test it in a production environment to confirm that it does not compromise line-of-business applications.

Handover to Deploy Phase

The trigger for handover to the Deploy phase of the patch management process is that:
The package is ready for deployment into production.
You have received approval to deploy the software update into the production environment.

Deploy

Overview

The fourth and final phase in the patch management process is the Deploy phase, which focuses on the tasks and activities required to deploy a software update into the production environment. Additional tasks may be required to deploy any countermeasures or mitigation steps.

The entry point for the Deploy phase is a determination that the software update is ready for deployment into production and that approval has been obtained to deploy it.

The goal for the Deploy phase is to successfully roll out the approved software update and/or any countermeasures into your production environment.

The deployment of a software update should consist of the following activities:
Deployment preparation
Deployment of the software update to targeted computers
Post-implementation review

Deployment Preparation

The production environment needs to be prepared for each new release. The steps required for preparing the software update for deployment should include the following:
Communicating rollout schedule to the organization
Importing programs and advertisements from test environment
Assigning distribution points
Staging updates on distribution points
Selecting deployment groups

Communicating Rollout Schedule to the Organization

It is important to inform end users and administrators about the impending release of an update. You should send a clear and easily identifiable e-mail message to users and administrators notifying them of the update and providing information about how to install it. This mail should be flagged for follow-up to remind users and administrators of the actions they need to take.

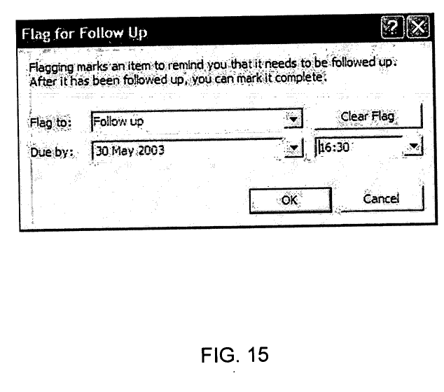

If you are deploying an update to desktops outside of core business hours, for example, the e-mail message should tell users to leave their computers on overnight on a specified date. If this message is flagged for follow-up as shown in FIG. 15, the users will receive a reminder at 4:30 P.M. on May 30, 2003, to leave their computers switched on for the night.

Importing Programs and Advertisements from Test Environment

To maintain the greatest reliability and security, always import the SMS 2003 packages you developed in test. Your test environment should be a good representation of your production environment. For software updates being deployed using SMS 2003 standard software distribution procedures, the package definition—which includes the programs associated with the package—should have been built and tested in the test environment. This package should be imported into the production Systems Management Server (SMS) 2003 environment.

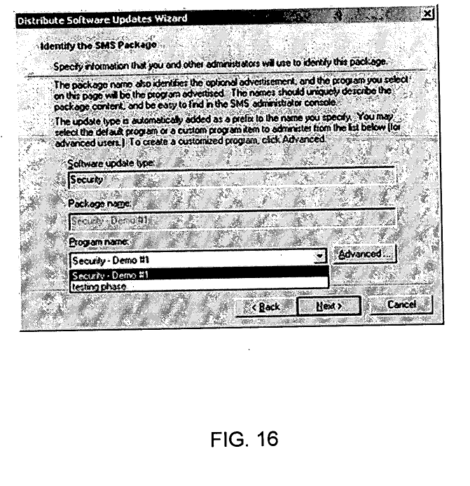

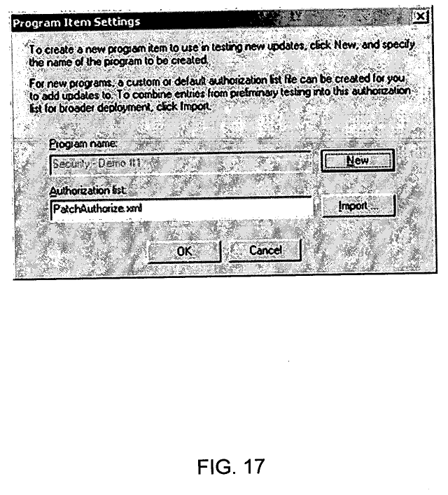

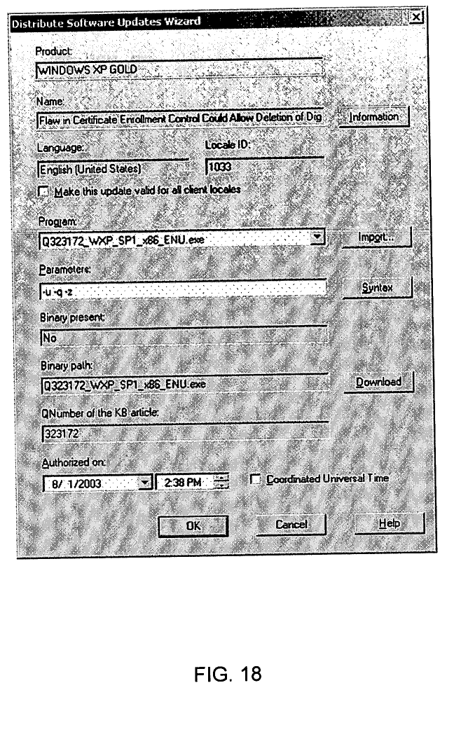

When you use the Distribute Software Updates Wizard, use the Advanced, and then the Import options on the Identify the SMS Package page to import the existing package from the test environment, as shown in FIGS. 16 and 17. The Advanced button allows the import of previously processed software updates from another authorization list, such as from a testing environment to a production environment. FIG. 16 illustrates the Advanced button. FIG. 17 illustrates the Import button. Use the Import button in the Distribute Software Updates Wizard, as shown in FIG. 18, which illustrates importing files that have been scanned for viruses.

Assigning Distribution Points

Once the package has been imported into SMS 2003, administrators should decide which distribution points should be used to make the software update available to client computers. The software update binaries should be placed on distribution points at all the sites where target clients are located. For software updates identified through the Security Updates Inventory Tool or the Microsoft Office Inventory Tool for Updates, distribution points are assigned as a step in the Distribute Software Updates Wizard, although these distribution points can be amended manually once the package has been created.

In general, software updates will be deployed to the same groups of clients and so the same distribution points will be used for each software update. For example, software updates for servers and server applications will need to go to all distribution points in the data center's site. Software updates for an accounting application will go only to distribution points in accounting department sites.

This allows distribution point groups to be set up in SMS that contain only distribution points for particular ranges of clients. Use of distribution point groups will speed up the process of assigning distribution points to software updates being deployed. The inventory information within the SMS database can be used to identify where new distribution points are needed.

Note Simply adding a distribution point to a distribution point group, however, does not cause the package to be sent to the new distribution point, even if the Update Distribution Points option is used. The distribution points are evaluated from the group only when the group is assigned to a package. New distribution points have to be added one by one to the package and then the distribution points updated.

Staging Updates on Distribution Points

Once the appropriate distribution points have been assigned, administrators should ensure that copies of all the individual files are distributed to these servers. The SMS status system should be used to monitor the distribution of the software update files. Until the distribution points have the files, clients within that site will be unable to install the software update.

The process of sending software update binaries to distribution points involves sending the files between SMS sites and from SMS sites to local distribution points.

Sending Updates Between SMS Sites

In most organizations, the intersite senders responsible for sending instructions, software packages, and advertisements between sites are often configured to limit either the amount of network bandwidth used or the times of day that transmission can occur. These restrictions are used primarily to ensure that software distribution occurs outside normal business hours, but they can sometimes be problematic when critical software updates need to be made available quickly. The SMS messages it Table 4 will assist in monitoring the site-to-site replication:

TABLE 4

| Message ID | Details |
|---|---|
| 3531 | SMS Sender is currently sending software distribution |
| | packages to the target site. |
| 3532 | SMS Sender encountered errors while sending software |
| | distribution packages to the target site. |
| 3533 | SMS Sender has successfully sent software distribution |
| | packages to the target site. |

SMS allows you to define package priority as High, Medium, or Low. For software updates that are not classified as business critical, you should only use the Medium or Low priority. High should be reserved for critical software updates only. The following are some guidelines around how the package priority affects the distribution of the software update:
The Distribution Manager is the component that compresses and processes packages. It will process packages in priority order. The package priority is mapped to replication priority for the Sender/Scheduler/Replication Manager.
If the Distribution Manager has already started compressing a Medium priority package, it will not stop the current processing to compress a newly created High priority package.
The priority evaluation of packages is done after the Sender has completed transferring the current package. Hence, if a Medium priority package is being transmitted and a High priority package is defined, then the Medium priority package transmission will complete before the priority is reevaluated.
The advertisement priority only affects the intersite replication priority; however, the advertisement objects are fairly small, so it makes little difference unless there is much pending traffic between sites.
The other components related to package/advertisements are Distribution Manager, Offer Manager, Replication Manager, Scheduler, Despooler, and Sender. All of these components observe priorities.

You can use the following SQL query to generate a report on percent complete of transfer of content for distribution to all sites. You should change all instances of the PackageID “BAR0001” to the actual PackageID in your environment before using this query.

declare@ver int

select@ver=MAX(SourceVersion) from v_PackageStatusRootSummarizer where PackageID=‘BAR00001’ create table #PkgProgress (RecordID int not null, Time datetime not null, SiteCode char(3) not null, PctComplete int not null, MessageID int not null, PRIMARY KEY(SiteCode,Time,RecordID)) insert into #PkgProgress(RecordID,Time,SiteCode,PctComplete,MessageID) select msg.RecordID, msg.Time, insSC.InsStrValue as SiteCode, IsNULL(insPC.InsStrValue,100) as PctComplete, msg.MessageID from v_StatusMessage msg join v_StatMsgAttributes att on msg.RecordID=att.RecordID and msg.Time=att.AttributeTime join v_StatMsgInsStrings insVER on msg.RecordID=insVER.RecordID and insVER.InsStrIndex=1 join v_StatMsgInsStrings insSC on msg.RecordID=insSC.RecordID and insSC.InsStrIndex=2 left join v_StatMsgInsStrings insPC on msg.RecordID=insPC.RecordID and insPC.InsStrIndex=3 where MessageID in (3531,3532,3533) and Component in (‘SMS_ASYNC_RAS_SENDER’,‘SMS_ISDN_RAS_SENDER’,‘SMS_LAN_SENDER’,‘SM S_SNA_RAS_SENDER’,‘SMS_X25_RAS_SENDER’,‘SMS_WINSOCK_SENDER’) and att.AttributeID=400 and att.AttributeValue=‘BAR00001’ and insVER.InsStrValue=CONVERT(varchar(10),@ver) select Sites.SiteCode, prog.Time, prog.MessageID, prog.PctComplete as ‘Sending % Complete’, Sites.Targeted as ‘DPs Targeted’, 100*Sites.Installed/Sites.Targeted as ‘% DPs Complete’ from v_PackageStatusDetailSumm Sites left join (#PkgProgress prog join (select SiteCode, MAX(Time) as MaxTime from #PkgProgress group by SiteCode) as LastProg on prog.Time=LastProg.MaxTime and prog.SiteCode=LastProg.SiteCode) on Sites.SiteCode=prog.SiteCode where Sites.PackageID=‘BAR00001’ and Sites.Targeted>0 order by prog.SiteCode drop table #PkgProgress

Emergency Change Request

You should lift all intersite restrictions and allow software updates to be sent to other sites as quickly as possible. If network links between sites are slow or are already congested, lifting restrictions on the intersite sender will have no effect. In these cases, administrators might consider sending the update to each site using the SMS Courier Sender.

Sending Updates to Distribution Points

Once the updates have reached the SMS site server, they are automatically distributed to any distribution points within the site. Administrators should monitor the SMS events shown in Table 5 for each distribution point:

TABLE 5

| Message | |
|---|---|
| ID | Details |
| 2342 | This indicates that SMS Distribution Manager is starting to |
| | distribute the package to a distribution point. |
| 2330 | This indicates that SMS Distribution Manager has successfully |
| | distributed the package to a distribution point. |

Note Before the client can install the software update, the policy must also be made available at the local management point.

Selecting Deployment Groups

When administrators use the Distribute Software Updates Wizard to distribute a new software update, they do not have to target computers precisely. This is because the wizard deploys a smart agent to the client, which is invoked when a new software update is to be installed. This agent automatically determines whether a software update advertised through the wizard is applicable to that computer and whether it has already been installed. It also handles chaining multiple software updates and the reboots needed to make them current.

Creating groups for targeting software updates installed in this manner should be based on:
The frequency at which computers should check for and install new software updates. (An SMS advertisement is created that checks for new software updates at specified intervals.)
Separate queries will be required to cover servers, workstations, and portable computers because each will have a different schedule and possibly run a different program to install the software update.
Separate queries will be required to cover computers in different departments or geographical locations because these will have different time zones. If you would like the update to be enforced at the same time in all time zones, include the Coordinated Universal Time check box in the Distributed Software Update wizard.

If administrators do not use the Distribute Software Updates Wizard, but the software updates are being distributed through a custom package and collection, then it is likely that administrators will need to create one or more SMS queries. For example:
Use a single query and a single collection based on that query, modifying the query for each phase of the rollout. Initially, the query is modified to reduce the scope of the clients targeted in the first phase of the rollout-for example, a single site or workgroup. As the rollout is expanded to more clients, the query is expanded so that its scope includes clients in the next phase of the rollout.
Changes to the query should be tracked and previous versions retained since this will enable administrators to roll back the software update in a controlled manner.

Deployment of the Software Update to Targeted Computers

The process you use to deploy the release into the production environment will depend on the type and nature of the release, as well as the release mechanism you select.

It will also depend significantly on whether the software update is an emergency. Because of the urgency associated with emergencies, there will be some differences in how you deploy them. Those differences will be highlighted throughout this section.

Ideally, software updates should be released through a phased deployment. By following a phased deployment, you minimize the impact of any failures or adverse effects that might be introduced by the initial distribution of a software update.

The steps required to deploy a software update in production should include the following:
Advertising the software update to client computers
Monitoring and reporting on the progress of deployment
Handling failed deployments

Advertising the Software Update to Client Computers

When administrators use the Distribute Software Updates Wizard, a repeating advertisement is automatically created to run the software update installation agent on computers in the target collection. The repeat interval can be altered from the default (seven days), as appropriate for the collection. For example, the collection including the servers may run the agent once per day or even more often.

Other things to consider are:
If you have a control group, deploy to those computers first.
If different schedules are needed for different types of computers, multiple advertisements can be created for multiple collections, using the same package and program.
If the repeat interval for running the software update installation agent is set to daily and it needs to be run sooner for the rollout of a critical software update, then a new, one-off, mandatory assignment should be made to run the advertisement as soon as possible.
If the rollout is being staggered, once rollout of the first phase is complete, you should modify the query to include clients in the next phase—for example, the next sites to be deployed. The collection is either updated manually or on a defined schedule, after which the software update installation program is automatically advertised to the new set of clients.
The SMS queries used for the target collections are based on inventory information indicating which computers do not have the software update being installed. As computers install the software update and are subsequently reinventoried, these computers will drop out of the collection when the collection updates because they will no longer match the query definition. After a new computer is added to the network and inventoried by SMS and when the collection next updates, the software update installation program will automatically be advertised to it if the software update is not on that new computer.

If you are not using the Distribute Software Updates Wizard to deploy the software update, you need to think about the following:
When an advertisement is set up to install a software update, its schedule should be configured to repeat at intervals. This is done so that a failed installation is retried automatically. If the advertisement does not repeat, you must retry manually, which requires you to create a collection for the failed clients and a new advertisement for that collection. These steps have to be repeated until all clients have been patched.
The repeat interval of such an advertisement needs to be chosen carefully because clients that have installed the release successfully will remain in the target collection until a new inventory has been collected—which may be triggered by the installation program itself—or until the inventory has been updated in the SMS database and the collection reevaluated. Therefore, the program could be rerun on a client that has already successfully run it once. For this reason, it is essential that the program to be run checks first to see whether the software updates are installed, and that it exits without delay if they are.

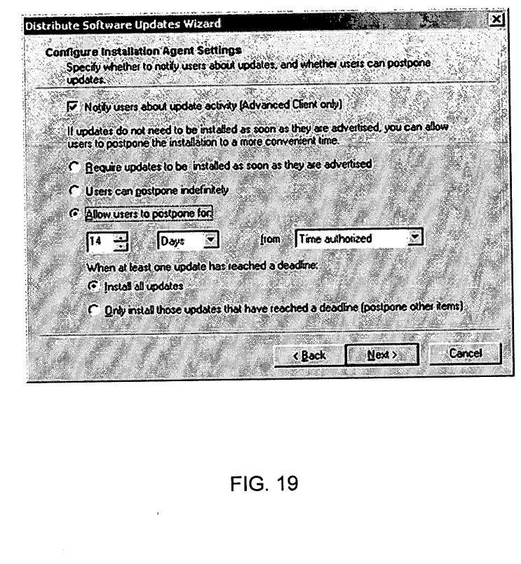

For noncritical software updates, SMS allows administrators to give the user the option of deciding when to install an update, with the update installing automatically after a specific deadline. This can be achieved in the Distribute Software Updates Wizard by selecting the Allow users to postpone for check box, as shown in FIG. 19.

Users and service owners should be informed that the software update is available for installation and that its installation will be made mandatory after a specific time. In this way, users of remote portable computers or users with computers connected across slow links have the option of choosing a convenient time to install the software update. Once the assignment date arrives, however, the software update will be installed automatically.

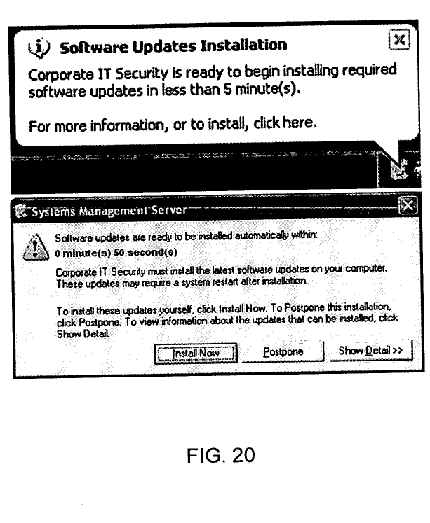

For software updates that are made available through the Distribute Software Updates Wizard, users will be notified about the updates being available by means of a balloon text. FIG. 20 illustrates a screen shot of an example of how users may be notified about available updates.

Administrators should build a query that will return the user name most recently logged on to the server, as well as the list of authorized updates that are missing from the target servers, so that you can easily notify the computer owners of their compliance levels and upcoming deadlines.

Emergency Change Request

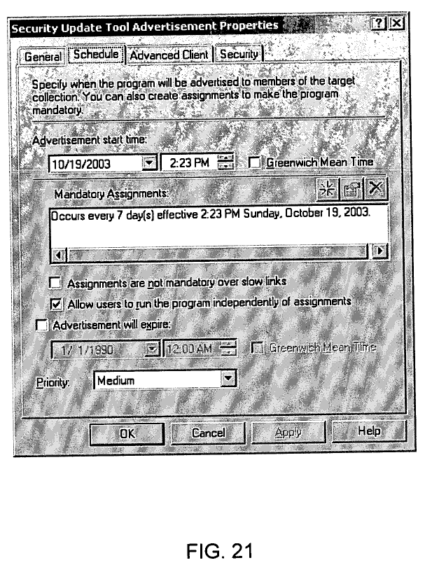

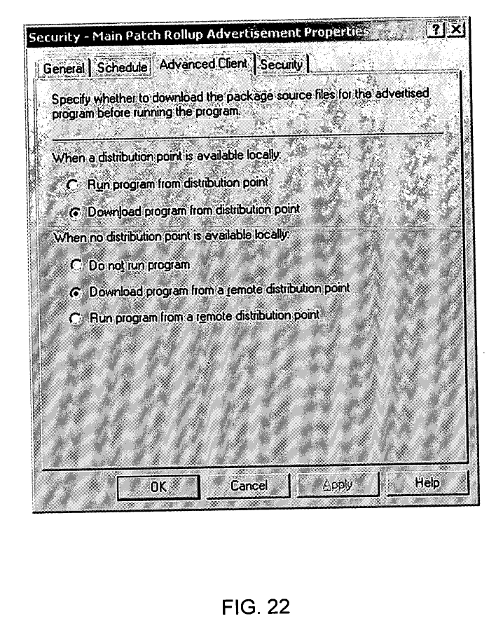

When the change request indicates that the software update is an emergency, administrators need to consider the following:
The deployment should start with an advertisement to a reference computer collection. A reference computer collection contains all representative computers in your production environment and hence is an important step in any phased/structure deployment. This approach will give you the confidence required to start deployment in the rest of your production environment.
Appendix F, “Building a List of Reference Computers,” provides a sample script to create a collection containing all representative computers in the environment.
You should install the software update on clients as quickly as possible, regardless of their connection and link speed to their SMS site or distribution point. Users of computers running the Advanced Client will be reminded of the deadline every three hours.
Administrators should ensure that, when they create the advertisement, the Assignments are not mandatory over slow links check box is unchecked, as shown in FIG. 21.
It might be better to ask users of portable computers to come into the office to install critical software updates, especially if the software updates are large or if the users connect through standard telephone connections or slow links. For users unable to come in to the office, it may be necessary to create an advertisement configured to download the software update onto the local hard disk and to execute it from there, as shown in FIG. 22.
In addition to the above, consider using protected distribution points to bind remote/portable computers to the distribution points. Ideally, the protected distribution point should be the one that is closest to the remote/portable users. Using the protected distribution points ensures that remote users will always use that distribution point for software updates. However, if a protected distribution point is not available, then the remote users will automatically fall back to the nearest/next unprotected distribution point.

Monitoring and Reporting on Deployment Progress

After a package has been deployed by advertising it to a collection of clients, administrators should determine whether the clients have successfully run the advertisement. There are a number of tools that can be used to check the status messages returned from SMS clients.

The SMS support tools include a tool called Advertisement Status Viewer that gives a view of the deployment status of advertisements, based on their status messages. When you check on the deployment status of an advertisement, however, it is often useful to know:
Which clients were in the collection but have not received the advertisement.
Which clients have received the advertisement but have not run it.
Which clients have run the program but had it fail.

Status messages can tell only whether the repeating advertisement was run. The Patch Install program, which is actually run, will install any new, approved software updates. To check that the program is running successfully on clients, you can analyze the status messages to determine when the program was last successfully run on each client. If the time since it was run is longer than the repeat period for any clients, you should investigate.

Status messages will also record the degree of voluntary versus enforced patching for end users and how those users are managing reboots and scheduled installation. Based on this data, it is possible to adjust enforcement and default settings to bring computers into compliance more efficiently. The messages is Table 6 can be used to review such information.

TABLE 6

| Mes- | |
|---|---|
| sage ID | Description |
| 11250 | Scheduled installation window missed (early start): Waiting to |
| | retry. |
| 11251 | Scheduled installation window missed (late start): Waiting to |
| | retry. |
| 11256 | Scheduled installation window missed (limit expired): Waiting to |
| | retry. |
| 11269 | System restart is needed for installation to continue. |
| 11257 | System restart required to install updates was rescheduled by the |
| | user. |
| 11258 | System restart required to install updates was postponed by the |
| | user. |
| 11259 | System restart required to install updates was postponed |
| | automatically. |
| 11252 | Installation was rescheduled by the user. |
| 11253 | Installation was postponed by the user. |
| 11254 | Installation was postponed automatically. |
| 11270 | Restart of the computer is required. |
| 11266 | Installation completed and restart was suppressed for the |
| | workstation role. |
| 11267 | Installation completed and restart was suppressed for the server |
| | role. |
| 11268 | Installation completed and a restart was not needed. |
| 11261 | Installation completed and a restart was rescheduled by the user. |
| 11262 | Installation completed and a restart was postponed by the user. |
| 11263 | Installation completed and a restart was postponed automatically. |
| 11264 | The required restart was initiated. |
| 11265 | The required forced restart was initiated. |

For software updates identified through the Security Updates Inventory Tool or the Microsoft Office Inventory Tool for Updates, you can use the built-in reports to check for successful deployment of a software update. The Compliance by Software ID report can be used to provide a summary of the total number of systems for which the update is installed or missing as well as the status relating to distribution of the software update. This reports helps identify the current compliance levels for a particular software update. This relies on updated invenotyr, so it will not be as up-to-date as looking at status messages.

Anaylze Results

As deployment progresses, there maybe a number of reasons why certain computers fail to install software update, including the following:
Computers are offline for various reasons—for example, users are not at work, users have to dial up, users are mobile users, and computers are undergoing maintenance.
Computers are being rebuilt or reimaged.
Computers with SMS clients are not communicating to SMS site servers since the last baseline/scan.
Computers have had their agent service stopped, either by users or as part of maintenance.
Computers have had access denied to them for various reasons.
Computers have XML 3 up to SP1 (SMS 2003 requires MSXML 3.0 SP4).
Computers have low disk space.

If one of those reasons results in some of your client computers not being patched within the given SLAs, you will need to determine what mitigating steps to take to bring them into compliance. Although you will not be able to patch all of your machines, you should make sure that you fully understand the reasons why those machines cannot or should not be patched. The following guidelines will assist you in addressing the failure of the software update to install and in bringing more of your computers into compliance:
Always rescan your environment after the first phase of deployment to identify the computers that were missed during the first phase.
Constantly monitor and report on deployment progress.
The rescanning and monitoring will result in subsequent redeployment phases to target computers that reported as exceptions.
Always triage to find the root cause of failed deployments.
For computers that are offline or are being rebuilt, you will get the advertisements as long as the SMS agent service is in a healthy state.
Refer to the guidelines throughout this section in order to increase the success rate of deployment.

Handling Failed Deployments

During the deployment, you might face exceptions. In a normal deployment you will have sufficient time to stop, determine the root cause, and redeploy. However, during an emergency deployment, the time available for triage and root cause assessment will be much shorter.

Your organization may also decide that a deployment is unsuccessful and needs to be stopped and rolled back. You must have a plan in place to stop the rollout, uninstall failed updates, and then redeploy them. The following are the activities involved in handling exceptions:
Stopping the deployment of the active package
Identifying and resolving issues
Re-advertising the package
Uninstalling the software update

Stopping the Deployment of the Active Package

In order to stop the deployment of an active package, you should:
From the packages node of the SMS Administrator console, select the program that you want to stop temporarily.
On the Program Properties Advanced tab, select the Disable this program on computers where it is advertised check box. Doing so will stop or pause advertisements based on the program even if they are assigned as mandatory and set to begin at a specific time or on a schedule.
Open the Distribute Software Updates Wizard and remove the check mark from the software update you are attempting to disable, and save the changes. Doing this will allow you to keep the advertisement enabled in the event there are other software updates that are running properly within this package.

Identifying and Resolving Issues

Using the standard reports in the Software Update Infrastructure Health category of the report viewer, you will be able to quickly identify any problems happening on clients attempting to install software updates, as well as well as any problems downloading the software update catalog from the Internet. It is important to catch issues early and resolve them, and to have a good working knowledge of typical software update return codes and status messages.

Typical problems can include:
Low disk space: Client computers must have at least 10 MB of available disk space.
Out-of-date XML parser version: MSXML 3.0 SP2 is the minimum required version if detected in a System File Protection (SFP) configuration. If SFP is not in place for the XML parser files, XML 3.0 SP4 is the required version and will be upgraded automatically. (SFP configurations will not be updated.)

The installation advertisement has run before the needed scan tool advertisement: This causes the installation agent to fail because the software update catalog is not available.

TABLE 7

| Name | Category |
|---|---|
| Compliance by product | Software Update - Compliance |
| Compliance by software ID | Software Update - Compliance |
| Computers where a specific software | Software Update - Compliance |
| update is applicable | |
| Software updates for a specific | Software Update - Compliance |
| computer | |
| Software updates not yet authorized | Software Update - Compliance |
| Software updates with count of | Software Update - Compliance |
| applicable and installed computers | |
| All computers with a specific software | Software Update - |
| update distribution status | Distribution Status |
| Distribution status summary of software | Software Update - |
| updates | Distribution Status |
| Software update distribution status by | Software Update - |
| software update ID | Distribution Status |
| Summary of software updates that failed | Software Update - |
| to deploy | Distribution Status |
| Computers that have returned software | Software Update - |
| update error messages for a specified | Infrastructure Health |
| advertisement | |
| Software update health | Software Update - |
| | Infrastructure Health |
| Software update status messages for a | Software Update - |
| specific computer within a specified | Infrastructure Health |
| number of days | |

Re-Advertising the Package

You can easily re-advertise a package, using the following guidelines:
You can resend the same package by adding an additional schedule to the existing advertisement. This procedure will force the client to reinstall the package, even if it has received the package and run it before.
You can keep rerunning the same advertisement by adding another schedule to the advertisement. This is an effective solution when you are doing test jobs on your lab computers and need to quickly resend the package. This procedure can help you adequately test the software updates before you deploy them in your production environment.
This is also a good solution for ensuring that new computers brought into the environment are patched.
You can easily resend an advertisement by right-clicking the advertisement and selecting All Tasks-rerun advertisement.

Uninstalling the Software Update

Some of the software updates released by Microsoft provide an uninstall path, whereas others do not. You will have to determine which ones can be uninstalled by reviewing the technical details of the security bulletin. This activity should have been done during the Identify phase of the patch management process.

To uninstall a software update using SMS, you need to know the uninstall command. Microsoft updates generally place a reference into the registry, including the uninstall command when an uninstall is possible. To uninstall a software update, do the following:
Create an SMS package and script that retrieve this information from the registry using a new advertisement.
Create the associated collection rules based on the information received from the registry above. Typically, you can use the software update inventory data as a collection rule, unless the software update does not provide scan tool detection. Without this, you might need a custom script or change to the SMS_def.mof to obtain the needed targeting details.
Create an SMS package containing the script that will run the uninstall command. Be aware of any command-line options needed to perform an unattended uninstall.
Distribute this package the same way you would deploy the release, by using the SMS advertisement procedures.

Post-Implementation Review

The post-implementation review should typically be conducted within one to four weeks of a release deployment to identify improvements that should be made to the patch management process. A typical agenda for a typical review includes the following action items:
Ensure that the vulnerabilities are added to your vulnerability scanning reports and security policy standards so the attack does not have an opportunity to recur.
Ensure that your build images have been updated to include the latest software updates following the deployment.
Discuss planned versus actual results.
Discuss the risks associated with the release.
Review your organization's performance throughout the incident. Take this opportunity to improve your response plan and include lessons learned. Consider the use of a synthetic software update that will not impact end users (no reboot) and allow your IT staff opportunities to practice deployments and measure the results.
Discuss changes to your service windows.
Assess the total incident damage and cost—both downtime costs and recovery costs.
Create another baseline or update the existing baseline for your environment.

Summary

The key activities you should have accomplished during the Deploy phase are the following:
Established the order in which the software updates will be rolled out into production.
Surveyed your production environment to ensure it is able to handle the software update.
Placed the software update files on distribution points.
Deployed the software update into production.
Rescanned your environment to assess success, and patched any computers that failed to install the software update.
Performed a review of the patch management process once the deployment is complete.

Next Steps

Once you have deployed the software update, you will return to the Assess phase, where you should continue to:
Inventory/discover existing computing assets.
Assess security threats and vulnerabilities.
Determine the best source for information about software updates.
Assess the existing software distribution infrastructure.
Assess operational effectiveness.

Operational Guidance

Operational Guidance Overview

This operational guidance outlines the daily, weekly, monthly, and as-needed tasks required to optimize the deployment of a software update into your production environment. Additional tasks might be required, depending on the environment, existing management procedures, and corporate standards.

For more information about the MOF Team Model role clusters referenced throughout this section, see the MOF Team Model white paper at http://www.microsoft.com/technet/treeview/default.asp?url=/technet/itsolutions/tandp/opex/mo frl/MOFTMl.asp.

Essential Maintenance Tasks

Table 8 below illustrates daily tasks that may be useful in optimizing the deployment of a software update.

TABLE 8

| Description | Process | Team Role Cluster |
|---|---|---|
| Perform an inventory on servers | Assess | Operations |
| Check production environment for | Assess | Security |
| unmanaged or rogue computers | | |
| Check for potential system vulnerabilities | Assess | Security |
| Check to ensure compliance with security | Assess | Security |
| standards and policies | | |
| Check Web sites, e-mail messages, and | Identify | Operations |
| other sources for information about new | | |
| software updates | | |
| Monitor progress of deployment | Deploy | Release |

Table 9 below illustrates weekly tasks that may be useful in optimizing the deployment of a software update.

TABLE 9

| | | Team Role |
|---|---|---|
| Description | Process | Cluster |
| Perform an inventory of workstations | Assess | Operations |
| Check that workstation inventory is up to | Assess | Operations |
| date | | |
| Ensure that software distribution tools are | Assess | Infrastructure |
| configured, maintained, and able to | | |
| support normal and emergency patch | | |
| management | | |
| Review non-emergency change requests | Evaluate | All |
| and determine the most appropriate | and Plan | |
| response | | |

Table 10 below illustrates monthly tasks that may be useful in optimizing the deployment of a software update.

TABLE 10

| Description | Process | Team Role Cluster |
|---|---|---|
| Check for new sources of patch | Assess | Operations |
| information | | |
| Review security standards and policies | Assess | Security |

Table 11 below illustrates as-needed tasks that may be useful in optimizing the deployment of a software update.

TABLE 11

| | | Team |
|---|---|---|
| Description | Process | Role Cluster |
| Review and update build baselines | Assess | Infrastructure |
| Identify the best source of information for | Assess | Security |
| new software updates | | |
| Review management architecture to | Assess | Infrastructure |
| determine whether it is able to support | | |
| patch management | | |
| Review patch management operational | Assess | Operations |
| processes and administration model | | |
| Confirm that people have assigned roles | Assess | Operations |
| and responsibilities and that they know | | |
| how to respond when an emergency | | |
| software update is identified | | |
| Perform physical audit of assets within | Assess | Infrastructure |
| the production environment | | |
| Review security vulnerabilities whenever | Assess | Security |
| changes are made or are proposed to the | | |
| production environment | | |
| Review notification of a new software | Identify | Security |
| update to determine that it is valid and | | |
| comes from a recognized source | | |
| Acquire files and confirm that they are | Identify | Security |
| virus free and that the software update | | |
| installs successfully | | |
| Confirm that a software update is relevant | Identify | Security |
| to computers within the production | | |
| environment and submit a request for | | |
| change (RFC) to deploy it | | |
| Review information supplied with a patch | Identify | Security |
| and, if necessary, perform an immediate | | |
| audit of computers at risk | | |
| Review emergency change requests and | Evaluate | All |
| determine the most appropriate response | and Plan | |
| Plan for the release of the software | Evaluate | All |
| updates into production | and Plan | |
| Develop the scripts, tools, and procedures | Evaluate | All |
| that will be needed to deploy the software | and Plan | |
| updates into production | | |
| Test that critical business systems | Evaluate | All |
| continue to work after deployment of the | and Plan | |
| software updates | | |
| Prepare the production environment for | Deploy | Release |
| the release of a new software updates | | |
| Deploy a software update and monitor | Deploy | Release |
| progress | | |
| Resolve issues with computers that fail to | Deploy | Release |
| install a software updates | | |
| Perform a change review to assess how | Deploy | All |
| successful the deployment of the software | | |
| updates was and whether the process | | |
| needs to be improved | | |

Project Guidance

The purpose of this appendix is to offer you high-level project management and testing guidance for deploying the components of the Patch Management Using Microsoft Systems Management Server 2003 Solution Accelerator. The solution accelerator contains:
Information about the prerequisites for conducting the solution accelerator and the role of Microsoft Systems Management Server (SMS) in managing software updates effectively (Chapter 1).
Solution guidance about the four-phase process for managing software updates (Chapter 2).
Operational guidance for conducting the essential maintenance tasks required to manage software updates effectively (Chapter 3).
A set of appendices that support the accelerator (Chapter 4), including this appendix.
Other materials, including the MSM Management Architecture Guide, which provides guidance on how to set up and configure tools such as Microsoft Systems Management Server 2003 (SMS) and Microsoft Operations Manager (MOM) to support patch management.

The project guidance offered by this appendix is based on Microsoft Solutions Framework (MSF). MSF provides proven practices for planning, building, and deploying a variety of technology solutions, combining aspects of software design and development, and building and deploying infrastructure into a single project life cycle for guiding technology solutions of all kinds.

You can find more information about MSF at http://www.microsoft.com/technet/treeview/default.asp?url=/technet/itsolutions/tandp/innsol/d efault.asp.

Solution Accelerator Overview

The Patch Management Using Microsoft Systems Management Server 2003 Solution Accelerator focuses on Microsoft's recommended four-phase patch management process, which is designed to give your organization control over the deployment and maintenance of interim software releases into your production environment.

The Microsoft-recommended patch management process contains these four phases:
Assess. The first thing you should do is assess your organization to evaluate its readiness to implement a formalized patch management process. This is less a step than an ongoing process that organizations should follow to ensure that they always know what computing assets they have.
Identify. The goal for the Identify phase is to discover new software updates in a reliable way, determine whether software updates are relevant to your production environment, obtain software update source files and confirm that they are safe and will install successfully, and determine whether the software update is a normal change or an emergency one.
Evaluate and Plan. The third step in the process is evaluation of the software update and—assuming that it is approved for deployment—planning for its deployment into your production environment.
Deploy. The goal of this fourth and final step is to successfully roll out the approved software update or software updates into your production environment so that you meet all of the requirements of any deployment service level agreements (SLAs) you have in place.

Project Team Prerequisites

In order to deliver a successful engagement, members of the team working on a patch management project should:
Be familiar with the key issues and technology around patch management and software distribution.
Be familiar with Microsoft Operations Framework (MOF) concepts and principles.
Understand Microsoft Solutions Framework (MSF) concepts and principles.

Solution Project Phases and Activities

Although MSF prescribes a five-phase process model—complete with major milestones and interim milestones—at a high level those phases fit into four major areas of concentration: planning, building, deploying, and operating.

Planning

To prepare for patch management, you should fully understand the business importance of patch management for your specific environment and the technologies and skills that you have (or don't have) for performing proactive patch management.

Next, you can assign teams and responsibilities to ensure patch management is carried out effectively, as part of normal operations. Successful patch management, like security and operations, is achieved through a combination of people, processes, and technology.

To determine how much effort to put into patch management, first assess the impact of poor (or reactive) patch management on the business, then determine if your organization's capabilities and infrastructure are sufficient to perform patch management effectively. Use this information to decide what your organization's goals for proactive patch management should be.

The business problem should document the impact to a business when it does not have a proactive patch management process in place. If a business only reacts to security problems (whether they are attacks by computer viruses and worms or targeted attacks instigated by perpetrators inside and outside an organization) after they occur, this can negatively affect the financial health as well as the related business goals and objectives of an organization.

Security programs such as patch management are more easily accomplished with executive support. Technology professionals can drive patch management infrastructure, tools, techniques, and processes, but without executive sponsorship it will be difficult to ensure sufficient resources and broad support for areas such as security policy, which must be applied across the organization to be truly effective. Clear business goals and supporting objectives should be created and understood by the sponsoring executives.

Once you have executive sponsorship and buy-in, the first step in deploying an effective patch management solution within your organization will be to summarize the tools and assets that are available to be used in patch management, and then assess the capabilities of the organization to perform patch management.

Operations Assessment

Through MOF, Microsoft offers a well-established process for conducting an operations assessment. The primary reason for conducting such an assessment is to ensure that you have the operational and technical capability to deploy software updates in your environment. Organizations desiring to implement patch management should possess the process maturity to support the following:
The ability to formally request a change.
The presence of an approval process for these change requests.
An environment and process for testing approved changes outside the production environment.
Application of risk management principles during planning and implementation in order to reduce the potential for negative impacts to the production environment.
Configuration management to support the planning and decision-making processes.

The operations assessment is conducted through:
Reviews of current documentation, procedures, employee handbooks, and orientation materials.
Employee interviews, including IT support staff, users, and senior management.
Observation of daily tasks.

The results from these activities are then compared with the minimum set of practices and standards necessary to successfully implement patch management.

Technical Assessment

The assessment team must also complete a technical assessment of the IT infrastructure, reviewing the implementation of SMS to verify that it is operated and maintained according to best practices. This service operates on top of other core IT services (for example, TCP/IP), which must also be verified for proper operation. The patch management solution architecture is optimized for specific configurations of SMS to support patch management. These include service pack installation, site structure, and file amendments, all of which are discussed within this solution accelerator.

Building

Recommendations for solution design are described in this solution accelerator, which includes solution architectural elements as well as specific design guidance. Using the recommendations and guidelines in this solution accelerator, the design team will create a design document that outlines how to perform the activities required during each phase of patch management. For example, the design document might describe how the organization registers for, receives, and monitors information about new software updates. Although the design may vary according to the size and complexity of the organization, you should follow the recommendations documented in the solution accelerator to assure best results.

Testing the solution prior to deployment is a basic requirement. The test environment should be configured to replicate the production environment to the greatest extent possible, and should include a representative sample of older and newer hardware, various baseline and line-of-business (LOB) applications, and servers. For each test described in the solution accelerator, there is information about the specific equipment and technical configurations required to perform each test, the steps that are required to carry it out, and the expected results.

Process testing is also required, although it is more conceptual in nature. To test operational processes, it may be necessary to simulate the various tasks required: from discovery of a new (simulated) software update through approval, testing, and deployment.

Deploying

Deploying a software update management solution is likely to require a phased approach. First, the organization must upgrade its service management functions to fill gaps identified during assessment. Next, the technical aspects of the solution are installed and configured, including the software update distribution infrastructure. Finally, the patch management process is layered over the hardware and software components to implement the service features, including patch subscription, notification, approval, testing, and deployment. This approach is described in greater depth elsewhere in this solution accelerator.

The solution deployment may include training activities for IT staff, as well as technical tasks. Staff members must become familiar with the necessary responses to a patch notification and how to integrate these responses into their operational environment. In addition to training for these specific tasks, you might want to provide more generalized operations training. This may be accomplished through formal training using courseware developed by Microsoft and delivered through a variety of vendors. Applicable courses include Microsoft Operations Framework Essentials, Microsoft Operations Framework Changing Quadrant, and Managing a Microsoft Windows 2000 Network and Environment.

Depending upon the solution architecture and configuration, some user training may also be required if manual interaction is required to install software updates on user devices.

Operating

Operations refers to the daily, weekly, monthly, and as-needed tasks required to deploy software updates into a production environment and how each of these tasks is allocated to a MOF team role.

This solution accelerator includes a chapter (Chapter 3) on those tasks. The project team must review these to determine which will be required for the patch management solution being created. Note that the “Operational Guidance” chapter list of tasks is not exhaustive and it is likely additional tasks may be required, depending upon your environment, existing management procedures, and corporate standards.

Once the list of tasks has been identified, the project team will work with the IT organization customer to allocate roles and responsibilities to groups or to individuals who will then carry out those tasks as part of their normal duties. In many cases, training, as described in the previous Deploying section, will be required to ensure that the roles meet performance requirements.

Operations Checklist

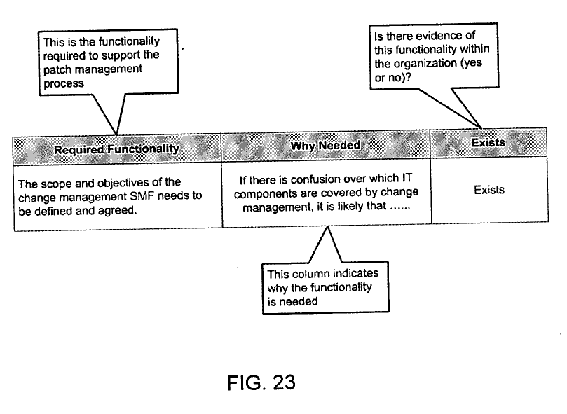

The Operations Checklist should be used to check that your organization has the minimum operational processes necessary to support patch management. If any of these processes are missing, you should determine whether they can be designed and implemented within the scope of the patch management project or if you will need to start a separate—and more wide-ranging—review of service management. FIG. 23 illustrates a checklist to ensure that an organization has minimum operational process.

Change Management

The organizational changes subject to the change management process include hardware, software, system components, documents, and processes—anything deliberately introduced into the IT environment that could affect its functioning as reflected in the service level agreements (SLAs) existing between the IT department and the business it serves.

Information in Table 12 is based on the MOF Change Management Service Management Function (SMF). More information about that SMF can be found at http://www.microsoft.com/business/reducecosts/efficiency/manageability/default.mspx.

TABLE 12

| | | |
|---|---|---|
| Required Functionality | Why Needed | Exists |

| | |
|---|---|
| The scope and objectives of the | If there is confusion over which |
| Change Management SMF need | IT components are covered by |
| to be defined and agreed to. | change management, it is likely |
| | that some changes will be made |
| | without reference to the process. |
| | This could lead to unscheduled |
| | outages, support problems, and |
| | inaccurate configuration data. |
| All change requests must follow | Organizations require a |
| an approvals process that prevents | disciplined process that can |
| them from being implemented | introduce needed changes into |
| until the necessary approval has been | their environment with minimal |
| granted. | disruption to ongoing operations. |
| Need to have a set of agreed | Priority setting is important as it |
| priority levels that indicate the | has a direct effect on the order |
| relative urgency of the change to | and timing of the review and |
| the business. | implementation processes. It is |
| | particularly important to assign an |
| | emergency priority classification |
| | to those changes that call for it, |
| | since this will expedite their path |
| | through the change management process. |
| Need to have a set of agreed | The change category is used to |
| change categories that can be | determine who needs to be |
| used to indicate the size of a | involved in the approval of a |
| change's impact on the business, | change. |
| the IT infrastructure, or the users. | |
| Change requests should be | The use of a standard form |
| submitted on a standard RFC | requires the change initiator to |
| form, which can be paper-based | provide enough information to the |
| or electronic. | change manager and subsequently |
| | the CAB to enable them to decide |
| | whether to implement the change. |
| | Using a standard form also forces |
| | the change initiator to identify |
| | and fully document the scope, |
| | implications, and risks of the |
| | change being requested, as well |
| | as the plans for recovery should |
| | the change be unsuccessful. |
| Change requests need to be | This process ensures that change |
| filtered for completeness, | requests are complete, are not |
| duplication, and practicality and | duplicates of other changes, and |
| returned to the initiator where | are of an appropriate nature. It |
| necessary. | improves the efficiency of the |
| | change management process by |
| | excluding requests that do not |
| | meet the required quality bar. |
| Different approval processes | More stringent approval |
| should be defined for each | procedures will be needed for |
| category of change. | complex changes or those that |
| | require major resources. A |
| | change advisory board (CAB) |
| | will normally be required to |
| | approve a major change to |
| | business-critical servers, for |
| | example. |
| There needs to be a process that | Time constraints for these |
| deals with emergency changes. | changes allow for only limited |
| | testing and require that normal |
| | processes and controls be |
| | bypassed. Therefore, an |
| | emergency change needs to be |
| | fast-tracked through the change |
| | management system. Emergency |
| | changes cannot be authorized by |
| | a single individual and must be |
| | approved through a change |
| | advisory board emergency |
| | committee (CAB/EC). |
| Changes need to be scheduled to | Using information relating to |
| reduce risk of failure, reduce | service availability and business- |
| likelihood of conflict with other | critical times, it should be |
| changes, and minimize impact on | possible to achieve minimal |
| the business. | impact and disruption to the |
| | business. |
| A schedule of forthcoming | The forward schedule of changes |
| changes needs to be made | shows when all changes are to |
| available to everyone within the | take place. Having a single |
| organization. | change schedule makes it possible |
| | to show when change windows |
| | (times during which changes are |
| | permitted) are available,. |
| After implementation, each | As well as making a |
| change needs to be subjected to a | success/failure decision on the |
| post-implementation review. | change, the review should also |
| | look at how the change was |
| | deployed and whether it was |
| | implemented on time and within |
| | budget. |
| All those involved in the change | People and processes play a |
| management process need to be | central role in the daily, weekly, |
| aware of their roles and | monthly, and as-needed tasks |
| responsibilities. | required to effectively deploy |
| | changes into the production |
| | environment for any organization. |

Configuration Management

Configuration management is a critical process responsible for identifying, controlling, and tracking all versions of hardware, software, documentation, processes, procedures, and all other inanimate components of the information technology (IT) organization. The goal of configuration management is to ensure that only authorized components are used in the IT environment and that all changes are recorded and tracked.

Information in Table 13 is also based on the Change Management SMF, referenced above.

TABLE 13

| | | |
|---|---|---|
| Required Functionality | Why Needed | Exists |

| | |
|---|---|
| The scope and objectives of the | If there is confusion over which |
| Configuration Management SMF | IT components are covered by the |
| need to be defined and agreed. | configuration management |
| | process, this may adversely |
| | impact the planning and |
| | assessment of changes to the |
| | production environment. |
| Information about IT components | The proper understanding and |
| and their relationships with other | documentation of relationships |
| components and services in the | between IT components makes it |
| production environment is recorded. | possible to perform detailed |
| | impact analysis on a proposed change. |
| As changes are made to IT | Without accurate information, the |
| components, the information | value of configuration |
| recorded about those components | management is significantly |
| must also be updated. | reduced. |
| At regular intervals, an audit of | Changes may have been made to |
| managed components within the | the production environment that |
| production environment should | have not been tracked or |
| be performed. | recorded. The results of the audit |
| | should be used to confirm that |
| | information held about IT |
| | components is accurate and up to |
| | date. |
| Automated tools are used to assist | Automated tools should be used |
| in the management of IT | to collect and record information |
| components. | about IT components within the |
| | production environment, maintain |
| | details of the interrelationships |
| | between these components, and |
| | support the planning and |
| | decision-making process. |
| All those involved in the | People and processes play a |
| configuration management | central role in the daily, weekly, |
| process need to be aware of their | monthly, and as-needed tasks |
| roles and responsibilities. | required to effectively maintain |
| | information about IT components |
| | in the production environment. |

Release Management

Release management is responsible for deploying changes into an IT environment. Once one or more changes are developed, tested, and packaged into releases for deployment, release management is responsible for introducing these changes and managing their release into the IT environment. Release management also contributes to the efficiency of change introduction by combining changes into one release and deploying them together.

Information in Table 14 is based on information from the Release Management SMF. More information can be found at: http:www.microsoft.com/business/reducecosts/efficiency/manageability/default.mspx.

TABLE 14

| | | |
|---|---|---|
| Required Functionality | Why Needed | Exists |

| | |
|---|---|
| The scope and objectives of the | The goal of release management |
| Release Management SMF need | is to ensure that all changes are |
| to be defined and agreed. | deployed successfully into the |
| | production IT environment in the |
| | least disruptive manner possible |
| | (a resultant risk of introducing |
| | change to it). |
| Releases are managed and | It is critical that releases are |
| implemented in accordance with | implemented in accordance with |
| the Change Management SMF. | the Change Management SMF. |
| | Each release should have a |
| | corresponding request for change |
| | and be assessed, approved, built, |
| | tested and implemented in |
| | accordance with the Change |
| | Management SMF. |
| Changes need to be implemented, | It may be appropriate, for |
| treating each release as a project, | example, to treat each RFC as a |
| to ensure a consistent delivery | simple release project, with its |
| mechanism and reduce the | own project plan and allocated |
| likelihood of failure. | resources. On the other hand, |
| | some benefits may be gained by |
| | combining the changes from one |
| | or more RFCs to form a more complex |
| | release. |
| A release strategy is generated for every | A release strategy document |
| release. | should be prepared for all |
| | releases. This document should |
| | contain the steps necessary to |
| | prepare the organization for the |
| | release, the risks it poses to the |
| | production environment, and the |
| | manner in which it can be |
| | removed from production if it |
| | fails to meet its objective. The |
| | existence of a tested and |
| | documented backout plan will |
| | reduce the impact on the business |
| | should a release need to be |
| | withdrawn. |
| Master copies of all software are | This will ensure a single point |
| stored in a single repository | where all authorized software is |
| (DSL). | stored and will assist in the |
| | effective allocation and |
| | management of licenses. The |
| | DSL needs to be reliable and |
| | available at all times. A number |
| | of copies can be made and placed |
| | in separate locations to ensure |
| | that the organization can rebuild |
| | and recover any site in the event |
| | of a disaster. |
| A schedule of forthcoming | A schedule of forthcoming |
| releases is maintained that details | releases is used by the Change |
| the contents of each release | Management SMF to ensure that |
| together with its proposed | approved changes do not conflict |
| implementation date. | with the implementation of a |
| | release. Furthermore, the service |
| | desk can use the schedule to |
| | advise users of periods of |
| | unavailability or to provide |
| | details of fixes contained within a |
| | specific release. |
| All releases are tested prior to | To ensure that releases do not |
| implementation. | adversely impact the production |
| | environment, each release should |
| | be tested in a facility that |
| | effectively models the conditions |
| | existing in production. The |
| | degree to which this can be |
| | achieved will be limited by the |
| | complexity of this environment |
| | and budget, but it should be |
| | sufficiently equipped to allow the |
| | release team and business |
| | representatives to build |
| | confidence in a release. |
| Information about releases is | Effective communications are |
| communicated to all interested | essential to the success of all |
| parties. | releases. Users, support staff, and |
| | others need to be made aware of |
| | and be prepared for deployment |
| | of any release. |
| Automated tools are used to assist | Automated tools should be used |
| in the deployment of releases. | to deploy releases (where |
| | appropriate) and provide detailed |
| | status reports that enable the |
| | release team to track and monitor |
| | the progress of deployment. |
| All those involved in the release | People and processes play a |
| management process need to be | central role in the daily, weekly, |
| aware of their roles and | monthly, and as-needed tasks |
| responsibilities. | required to effectively deploy |
| | releases into the production |
| | environment. |

Test Guidance Overview

This section provides a high-level description of the test objectives, scope, strategy and methodology necessary to validate the patch management solution you have built. This section is supplemented by the “Test Case Details” workbook, which provides the details required to execute the test cases used in this test plan.

Your testing should be done to accomplish two primary objectives:
Ensure that the solution meets business objectives as defined in the business/scope documentation.
Confirm that the solution works as expected.

What Needs Testing

As with most projects, the amount of time allocated to predeployment tasks such as testing is limited by time, resources, budget, and the needs of the organization. These constraints limit the amount of time available for testing, along with the scope and depth of the tests performed. Because the number and scope of these tests depend on an organization's requirements and business objectives, it is not possible to recommend a minimum number of tests that will provide a sufficiently high degree of confidence to proceed with deployment.

The focus of testing, therefore, must be on what an organization sees as the key aspects of functionality. Although there might be other aspects of the solution that could generate issues, these are less important and hence merit a reduced level of testing.

Who Should Perform Testing

The number of people involved in a solutions test team depends to a large extent on the complexity of the design, the amount of time available, and the underlying business priorities. Someone with proven, in-depth technical skills should lead the team. Ideally, the test team should also include a number of people from the teams who will be responsible for supporting the patch management solution after it is deployed. The team as a whole should have a good understanding of the business, the business objectives, and the reasons behind the deployment.

How to Carry Out Testing

The best approach to testing is to start with basic functionality and gradually add levels of complexity at each successive stage. As each test is completed, the results should be documented and verified against the project requirements. Any problems should be investigated and resolved.

Where to Perform Testing

The test lab should closely resemble or, ideally, mirror the production environment. The degree to which this can be achieved depends on the complexity of the production environment and the amount of time and money the organization is prepared to commit to the test lab.

If the organization uses standard client and server hardware configurations, use these configurations in the lab. As far as possible, use the same hardware, software, network, logon scripts, and so forth used in the production environment. If the production environment includes computers with nearly full disks, obsolete and possibly unused software, or an assortment of different network adapter cards, the lab computers should have the same characteristics. If routers or slow links connect production networks, duplicate these conditions in the lab.

The goal of testing is to obtain approval (or certification) for a product to be deployed in production. If the lab environment mirrors the production environment, then systems and applications can be certified with confidence that the lab test results represent what to expect in production.

Test Cases and Details

The detailed set of test cases that forms the core of the solution testing program is documented in the Excel workbook that accompanies this document. These tests have been divided into several categories, representing the project phases. A general description of testing for each of the project phases is described in the sections below.

Individual test cases are identified throughout the detailed test plan. To prevent unnecessary duplication of tests, certain test cases have not been included where the functionality relied on has already been tested in prior test cases.

These test cases are grouped and numbered according to the process within patch management to which they refer. During actual testing, an additional column is typically appended to the worksheet to indicate whether the test passed or failed. This column has been omitted from the tables below to eliminate unneeded complexity.

Assess

The Assess phase of the patch management process permits an enterprise to effectively assess and baseline its existing IT environment in order to prepare for patching. Test cases provided in the solution for this phase include a series of tests to determine infrastructure inventory and verification of IT capabilities to perform various evaluation activities as shown in Table ?.

TABLE 15

| | | Test | |
|---|---|---|---|
| Process | | Case | |
| Stage | Test Scenario | ID | Required Functionality |
| Assess | Inventory: Test | 1 | Resource discovery in the network |
| | ability to | 2 | Resource discovery in the SBO site |
| | inventory | 3 | Identify the unmanaged computers |
| | network resources | 4 | Identify perimeter servers |
| | and identify | 5 | Identify SBO servers |
| | servers. | 6 | Identify SQL cluster |
| | | 7 | Create a collection |
| | Baseline: Verify | 8 | Identify the currently installed |
| | the ability to | | security updates |
| | inventory the | 9 | Identify the currently installed Office |
| | currently installed | | updates |
| | software updates | 10 | Compare between SMS patch |
| | and identify | | detection and MBSA |
| | missing ones. | 11 | Schedule a hardware inventory |
| | | 12 | Identify the missing software |
| | | | updates for Exchange 2000 Server |
| | | 13 | Identify the missing software |
| | | | updates for SQL Server 2000 |
| | | 14 | Identify the missing software |
| | | | updates for Windows Server 2003 |
| | | 15 | Identify the missing software |
| | | | updates for Windows XP |
| | | 16 | Identify the missing software |
| | | | updates for Microsoft Office |

Identify

The Identify phase helps an organization to identify the need, relevance, and impact of applying a software update to its existing environment. Testing processes in the Identify phase includes verification that patch notifications may be received, that the current status of patching within the organization may be determined, that software updates can be downloaded, and that the authenticity of downloaded software updates can be verified.

The test cases documented for this phase include:

TABLE 16

| | | Test | |
|---|---|---|---|
| Process | | Case | |
| Stage | Test Scenario | ID | Required Functionality |
| Identify | Notification: Test | 17 | E-mail notification |
| | the ability to | 18 | Ability to identify new software |
| | identify recently- | | updates in environment since last run |
| | installed software | 19 | Ability to obtain Exchange software |
| | updates and | | updates |
| | obtain new ones. | 20 | Ability to obtain SQL software |
| | | | updates |
| | | 21 | Ability to obtain Office software |
| | | | updates |
| | | 22 | Ability to obtain Security software |
| | | | updates |
| | Verify: Test | 23 | Verify the software update digital |
| | ability to verify | | signature |
| | patch security. | 24 | Ability to detect missing digital |
| | | | signature |

Evaluate and Plan

The Evaluate and Plan phase of patch management is the interval when the organization evaluates the potential impacts of either deploying or not deploying a particular patch. After a decision is achieved to deploy, the patch management team plans the release and prepares to do so. A critical part of this process is to determine if a software update may be successfully uninstalled without damaging the infrastructure. The test cases identified for the Evaluate and Plan phase include the following:

TABLE 17

| | | Test | |
|---|---|---|---|
| Process | | Case | |
| Stage | Test Scenario | ID | Required Functionality |
| Evaluate | Release Planning: | 25 | Create a package for Exchange |
| and Plan | | | software update |
| | Test ability to | 26 | Create a package for SQL software |
| | create packages. | | update |
| | | 27 | Create a package for Windows |
| | | | Server 2003 software update |
| | Acceptance Test | 28 | Create a package for Windows XP |
| | | | software update |
| | | 29 | Create a package for Office |
| | | | software update |
| | | 30 | Test if software update can be |
| | | | uninstalled |

Deploy

Testing that is completed for the project's Deploy phase is focused on verifying that software updates may be successfully deployed, that they will install correctly under a variety of scenarios, that the software update deployment system is fault tolerant, and that the system can be restored to a prepatch configuration without errors. The test cases applied to verify these conditions include the following:

TABLE 18

| | | Test | |
|---|---|---|---|
| Process | | Case | |
| Stage | Test Scenario | ID | Required Functionality |
| Deploy | Phased | 31 | Installation of multiple software updates |
| | Deployment | | with a single reboot |
| | | 32 | Patching management architecture |
| | | 33 | Deploy software updates to select |
| | | | resources |
| | | 34 | Deploy software updates over low |
| | | | bandwidth |
| | | 35 | Deploy software updates to perimeter |
| | | | servers |
| | | 36 | Deploy software updates to servers |
| | | | in the same network |
| | | 37 | Deploy Exchange software update |
| | | 38 | Deploy SQL software update |
| | | 39 | Deploy Office software update |
| | | 40 | Amend packages to add new software |
| | | | update to an old advertisement |
| | | 41 | Install the software update when a |
| | | | user is not logged on |
| | | 42 | Deployment of software update |
| | | | during an outage window |

Mapping Patch Management to MOF

MSM version 2.5 includes a high-level, four-stage process model for patch management that may be similar to the top-level activities illustrated in FIG. 1. This model is a higher-level abstraction of the full end-to-end MOF patch management process model used in earlier versions of the MSM patch management offerings.

The four phases of the model map to the full end-to-end process as follows:
Assess

In the Assess phase of the high-level model, you determine what you have in your production environment, what security threats and vulnerabilities you might face, and whether your organization is prepared to respond to a software update.

This phase incorporates the initial setup activities of baselining and subscription described in previous versions of MSM:
Baselining is the process by which you identify what versions of software you want to manage.
Subscription is how you work out the best sources of information about new software updates for the versions of software you've decided to manage.
Identify

In the Identify phase, once your organization becomes aware of a new software update, you determine whether it is relevant to computers within your production environment. If it is relevant, you submit a change request to gain approval for deploying the software update into production.

This phase incorporates the identification activities of Identification, Relevance, and Quarantine, and the Change Management SMF activity of submitting a change request described in previous versions of MSM.
Identification is how organizations are notified of new software updates, how they screen them, and how they validate them.
Relevance is how organizations determine whether they have the operating systems or applications that need to be patched, and, if they do, whether they have the vulnerabilities in question.
Quarantine is the process by which organizations look at any software update in isolation to prevent virus infection or malicious code affecting their IT infrastructures.
Change request is a formal request to make the changes required to deploy a software update.
Evaluate and Plan

By the end of the Evaluate and Plan phase, you should have made a go/no-go decision to deploy a software update and have determined the necessary tasks that will be needed to deploy it into production. You should also have tested the software update in a production-like environment to confirm that it does not compromise business-critical systems and applications.

This phase incorporates the following activities from the Change Management SMF and the Release Management SMF:
Change classification, which is the assigning of a priority and a category to a proposed change, using its urgency and its impact on the infrastructure or users as criteria.
Change authorization, which is consideration and approval or disapproval of a proposed change by the change manager and the CAB.
Change development, which is the planning and development of a change, a process that can vary immensely in scope and includes reviews at key interim milestones.
Plan release, which is the process whereby the release manager determines what needs to be done to the production environment to implement a change.
Release development, which is the phase during which members of the release team develop the processes, tools, and technologies required to deploy the release into the production environment.
Acceptance testing, which is the process for ensuring that releases will not adversely impact the production environment. Each release should be tested in a facility that effectively models the conditions existing in the production environment.
Rollout planning, which is the stage at which the release manager reviews the rollout order to determine whether it is still aligned with business requirements and priorities.
Deploy

The goal for the Deploy phase is to successfully roll out the approved software update into your production environment so that you meet all of the requirements of any deployment service level agreements (SLAs) you have in place.

This phase incorporates the following activities from the Release Management SMF:
Rollout preparation is getting the production environment ready for each new release, which generally includes communicating information about the release to users and other personnel, training service desk and technical support staff, and making backups of critical IT components.
Release deployment, which is the process of moving the release into the production environment.
Change review, which is the process of determining the effectiveness of the change.

Configuration management, which spans all phases of both models, is a critical process responsible for identifying, controlling, and tracking all versions of hardware, software, documentation, processes, procedures, and all other inanimate components of the information technology (IT) organization.

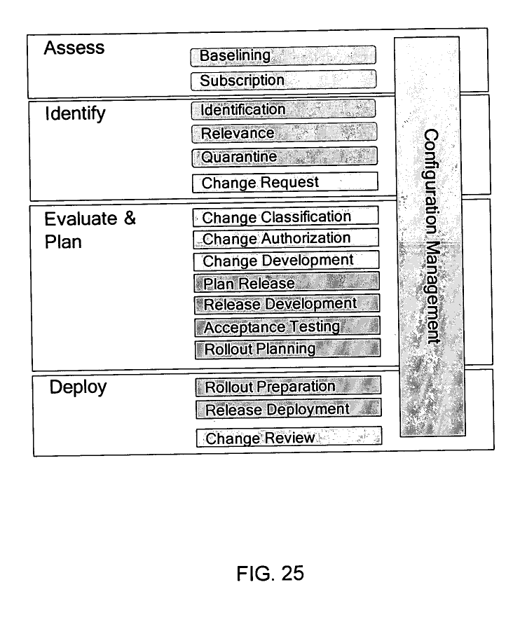

FIG. 25 illustrates how the high-level four-phased process maps to the MOF patch management process model used in earlier versions of the MSM patch management offerings.

Emergency Security Response

Overview

Even with the best patch management process, your technology environment can still be successfully attacked. Not all vulnerabilities are resolved by the application of security updates; some vulnerabilities may be related to weak computer security configurations.

Alternatively, a software vulnerability could be exploited before a security update is available, or even before it has been publicly reported—otherwise known as a “zero day” attack. Perhaps a vulnerability that has recurred in the environment has been exploited before being addressed.

Regardless, it is not necessary to understand why you are vulnerable in order to realize that an emergency security response may be necessary. To deal with the emergency effectively, you need to have an incident response plan in place. This appendix identifies key ways to prepare for an emergency, provides several ideas for an incident response plan, and gives prescriptive measures and ideas on how to minimize impact and take control during an emergency situation.

Evaluation

The first step in the emergency response scenario is to identify and define the emergency. If you are in an emergency situation, the attack requires immediate attention. How vulnerable are all of your systems? You need to be able to immediately prioritize the resources needed to fight the emergency based on asset valuation.

When your intrusion detection system or other indicators tell you that you're under attack, as part of your evaluation, you need to:
Identify the nature of the attack. Is the attack a distributed denial of service (DDoS) attack, or an attack targeted just at you? Is someone trying to shut down your network altogether, or attempting to infiltrate individual computers?
Localize the source. Use your firewall and audit logs to attempt to identify where the attack originated. This will help you identify whether the attack is coming from a compromised host on your own network or from the outside world.

Notification and Escalation

Proper communication is critical to managing an attack. Depending on the type of attack, determine exactly who needs to know that an attack is underway. During a targeted attack, don't tip off the attacker with company-wide communications—keep attack communications contained to the people who have a need to know.

With a virus or worm, company-wide communication that reaches all employees both onsite and remote may be appropriate. Keep in mind that communication technologies may also be under attack. You should have a contingency plan in the event any of your usual communication methods are unavailable.

Be sure to communicate appropriately. Make the communication to the point, informational, and constructed to alleviate any panic. If you have specific company guidelines for communications, make sure to follow them so that the recipients trust the message. These guidelines may need to be revised to accommodate emergency situations.

It is very important that all those who are involved in an incident response communicate effectively. Doing so will help ensure that decisions are made without duplicating effort, and that no steps of the process are missed. The incident response team should be the focal point for all communications.

Contact Your Technology Vendors

If a Microsoft product is involved in the attack, notify Microsoft Product Support Services at (866) PC SAFETY or (866) 727-23389 for free virus- and security update-related support in the United States and Canada. For other locations, contact Microsoft Product Support Services worldwide at http://support.microsoft.com/common/international.aspx.

If you have Microsoft Premier Support, contact your Technical Account Manager using his or her contact information.

Microsoft has security and incident response experts who can help you understand an attack and assist you throughout the incident response process.

Contact Law Enforcement Agencies

Intrusions can be a criminal event. Consider notifying the appropriate law enforcement agency if you are under attack, and understand and comply with your local jurisdictional requirements for involving the authorities and informing those that may be affected by the intrusion.

Many government agencies have extensive experience (likely more experience than your organization will have) assisting organizations with Internet intrusions and subsequent prosecution. Reduce your risk in an emergency situation by involving them!

Note: In the United States, there are several agencies that you can contact when you are under attack. The United States Department of Justice provides information on how to report Internet-related crime at http://www.usdoj.gov/criminal/cybercrime/reporting.htm.

Contact Legal Counsel

It is a good idea to contact your organization's legal counsel at this point to collaboratively determine if legal prosecution is a possibility after the event, depending on the nature of the attack. If legal prosecution is an option, throughout the event process your organization should maintain a log of the business impact of the attack (damages) and take additional steps to protect the evidence, such as:
Keep backup copies of any logs you generate on read-only media, and take detailed notes so that you have a good evidential record of what happened and when. Include checksums of all data collected on the same read-only media to prove that it wasn't tampered with.
Save the running system state (services, ports open, user accounts, memory maps, and so on) and create a forensic image of the suspect drive.
If protecting evidence is critical and a backup computer (and data) is available, don't attempt to change or fix the affected computer. Turn off the affected computer and introduce the backup computer after ensuring that it does not have any vulnerabilities that would make it susceptible to attack. Just as in a crime scene, the more you do to an affected computer the greater the chance of destroying evidence.

Isolate and Contain

Although uptime is very important in most environments, keeping computers available during an attack may result in more damage. Balance the impact of an ongoing attack with the impact of an appropriate defense.

Attacks that destroy, manipulate, or divulge sensitive data or that require a full computer reinstallation to recover from, may merit taking computers offline to protect them. Less intrusive attacks, such as some denial of service attacks, may not require a response this severe. In most cases, the source of an attack should be removed from the network to isolate and minimize proliferation, regardless of the type of attack.

When you take extreme measures that impact the business, you should track them closely so that they can be successfully removed after the incident is resolved.

The following are several activities that you may choose to perform to isolate and contain an attack:
Disable access points. Determine which access point(s) the attacker used and implement measures to prevent ongoing access. Such measures may include disabling a modem, shutting down virtual private network (VPN) and remote access servers, adding access control entries to a router or firewall, or physically disconnecting network equipment.
Protect classified, sensitive, and proprietary data. As part of planning for incident response, you should clearly define which assets contain sensitive information that needs to be protected. Depending on the nature of the attack, you may choose to shut down these computers or turn off specific services.
Protect software against attack. This includes protecting against loss or alteration of system files. Damage to software can result in costly downtime.
Block the attack. If an attack or attempted attack is coming from outside, block access to your network from that IP address. Some attacks change the range of the source IP address, so you may need to analyze the traffic and block specific ports.

If you're the target of a distributed denial of service (DDOS) attack, you may want to work with your ISP on a coordinated response.

There are also specific items you may want to turn off or disable during an attack. Some of these are:
Remove attack-source computers. If you've identified specific computers that have been compromised and are involved in the attack, you may want to pull them from the network until you can disinfect them and return them to service.
File shares. If the attack uses the context of the user to gain access to files and data for destruction, set all file shares to read-only to allow most work to continue but prevent attacks from causing further damage.
Virtual private network or remote access. To protect your remote users from the attack, you may choose to disable the ability for remote users to connect to the company network. The attack could spread to those users who are connecting, or the attack could be coming from a remote user.
Internet connection. Shut down the Internet connection to the outside world. Not only could this halt the attack should it be coming from outside of the company, but it can also contain the attack before you infect other locations.
Internal connections. Try to contain the attack by disabling connections to other company offices or geographic locations.
Stop services and applications. Certain vulnerabilities depend on specific services running in order to propagate themselves. Shut down services that could proliferate the attack.
Shut down or block ports. Block ports at the firewall. Vulnerabilities that attack from the outside generally depend on specific ports or port numbers to be open. Review the documentation from your networking hardware vendor for more information.
Change passwords for elevated privilege accounts. Various vulnerabilities attempt to guess the password for specific accounts. Administrator and Guest accounts and accounts that run with high privilege are favorite points of attack. Change these passwords immediately when confronted with an attack.

Note: For more information on using IPSec to block ports and secure a server, see Using IPSec to Lock Down a Server at http://www.microsoft.com/technet/itsolutions/network/maintain/security/ipsecld.asp.

For scripts that can start and stop services remotely, see the TechNet Script Center for Services at http://www.microsoft.com/technet/scriptcenter/services.

For scripts that can remotely change passwords and lock accounts, see the TechNet Script Center for Users and Groups at http://www.microsoft.com/technet/scriptcenter/user.

Analyze and Respond

To be able to recover effectively from an attack, you need to determine how seriously your environment has been compromised. This will help identify how to contain and minimize the risk, how to recover, with whom you should communicate the incident, and whether to seek legal redress. In general you should attempt to:
Determine the nature of the attack, which may be different than your initial assessment suggests.
Determine the point of origin of the attack.
Try to determine an attack signature so you can recognize when new computers are being attacked.
Determine the intent of the attack. Was the attack specifically directed at your organization to acquire specific information, or was it a random attack?
Identify which computers have been compromised.
Identify the files that have been accessed and determine the sensitivity of those files.

Remediation

If computers need to be recovered from an attack, it is always best to rebuild a fresh system. Consider rebuilding a fresh system with new hard disks using your up-to-date, secure baseline. Ensure that you change any local passwords and address the vulnerability that was exploited during the attack. You should also change administrative and service account passwords elsewhere in your environment.

If Microsoft or your virus vendor provides a recommended way of cleaning a computer from a virus or worm that doesn't require a full reinstallation, this option may be preferable because of the time and cost saved.

However, there is always a chance that an attacker opened several back doors after your computer was compromised during an attack (for example, several viruses leave back doors for future exploits). When a computer has been compromised by an attack of any kind, the safest way to return it to service is to reinstall the operating system, reload applications from a known good backup or baseline that applies an up-to-date security policy, and ensure the exploited vulnerability has been addressed.

Even though it might be tempting to address the compromise quickly and get the computer back on the network, it is risky to do so, because it is impossible to determine what back doors or changes to the computer the attackers have left.

Note: CERT maintains a list of Steps for Recovering from a System Compromise, which is available at http://www.cert.org/tech tips/root compromise.html.

Accelerated Release Management

When fixing problems across the environment in response to an attack, use your current change and release management processes as a guide, performing only those steps that are required to quickly and effectively respond to the attack.

If an attack can be resolved with the application of a security update or countermeasure, determine how to quickly install it throughout the organization. The risk of the vulnerability being exploited during an attack is significantly higher than normal, so you may decide to perform only basic testing during an emergency.

Take all of the company's technology assets into account. During an attack, not all assets may be connected to the network—for example, remote users may need to be addressed. If you deploy an accelerated release, you may need to deploy it again when remote computers return, or have them install it before they can connect.

If you do not have a software update distribution infrastructure already in place, consider sending users to Windows Update or Office Update to install a security update or putting an emergency Software Update Services infrastructure in place.

As long as your connection to the Internet has not been disabled during an attack, computers can download and install the security update from Windows Update. This method is also extremely useful for remote users. You can communicate to them the importance of the security update and give instructions for how to use the Windows Update Web site.

As a last resort, should an attack impact network services, consider the manual deployment of a security update. This would involve visiting each computer and applying the release, or providing CDs and installation information to all users in a coordinated manner.

Monitoring and De-Escalation

After you have installed a release in the production environment, continue to monitor your computers and network. Watch for a recurrence of any attack signatures determined when learning about the attack. As well as monitoring existing servers, it is important that you monitor the environment as a whole to ensure that new computers added to the network are not vulnerable, thereby enabling the attack to start again.

De-escalation indicates a return to normal business operations. De-escalation typically occurs when none of the parties involved in the incident are identifying or reporting new information.

Post-Incident Activities and Review

After the incident is over and the attack is no longer considered an active threat, there are a few wrap-up activities that should be performed, including:
Submit a change request following your organization's typical change process and re-release any production changes that were required during the attack. If testing was skipped earlier, now is the time to properly ensure that the implemented production changes do not negatively impact the security and reliability of your environment.
Ensure the vulnerabilities that were exploited are added to you vulnerability scanning reports and security policy computer standards so the attack does not have an opportunity to recur.
Assess the total incident damage and cost—both downtime costs and recovery costs.
Review your organization's performance throughout the incident. Take this opportunity to improve your incident response plan.

Rapid Deployment Procedure

SMS administrators will often be forced to deploy software updates that relate to an emergency change request within a very short deadline, typically within 8-24 hours of the organization receiving notification that the software update exists. The following process shows the steps that need to be taken to distribute the software update using the Distribute Software Updates Wizard and force business-critical servers to install it. A similar process could also be followed for software updates that apply to workstations.

Note This process can only be successful in business locations where there is sufficient available network bandwidth to allow the software update files and the updated software distribution policies to be made available to client computers.

To distribute the software update using the Distribute Software Updates Wizard and force business-critical servers to install it

1. Run the SyncXML.exe program from the Run Available Programs or Advertised Programs Manager tools found in Control Panel.

This must be done on the computer hosting the synchronization task (initially created by scan tool setup to be the SMS site server computer.) This will ensure that the newly released catalog is available locally.

2. Manually refresh the distribution point of this package to keep the new catalog flowing to other sites and other distribution points in the environment. Ensure all distribution points have completed their update.

The distribution points being refreshed are needed for any legacy or SMS 2.0 clients. The Advanced Client will automatically enter a waiting content state if needed because the new program item(s) will have a policy that reflects the new package version needed.

3. Create a new program item within the existing scan tool package, observing the “expedited” form of the program (command line includes “/s/cache/kick”). This program will be used to ensure preproduction collection members observe the latest version of the catalog in their next available scan cycle.

4. For ease of use, name this new program after the specific bulletin ID or KB number associated with the new software update. For example, “Expedited MS03-039.”

5. Advertise the new “expedited” scan tool program to the reference computer collection.

Because this is a new program, the preproduction computers will be forced to download the associated package version, containing the new catalog.

6. Create a second new program item within the existing scan tool package, observing the non-expedited form of the program (command line includes “/s/cache”).

7. For ease of use, name this new program after the specific bulletin ID or KB number associated with the new software update. For example, “Non-expedited MS03-039.”

8. Use the Distribute Software Updates Wizard to create a new package for just the software update. Use the Refresh button as needed while client inventory is being processed to ensure all available preproduction computer inventory is leveraged. Authorize the software update based on the results from the preproduction collection. (While production systems are scanning, you have time to prepare the package.)
Select the Collect client inventory immediately (may increase system activity) check box in the first client agent settings page of the Distribute Software Updates Wizard if you want to have inventory data sent to the site server sooner than the scheduled Hardware Inventory Client Agent schedule.
Verify if you intend to use the Universal Coordinated Time behavior to enforce software updates in unison globally rather than by time zone. This is a per-software update setting.
Be sure to specify the existing scan tool package and program at the appropriate page of the wizard, not the new program.
Do not advertise at this point in the Distribute Software Updates Wizard.
The use of a new package will ensure the download and execute phase happens as quickly as possible since the other software updates you may be managing are defined to be less critical than the current activity.

9. After Distribute Software Updates Wizard closes, open the property page for the new Distribute Software Updates Wizard program and include the program dependency on the newly built nonexpedited program.

The program dependency will cause clients to run the scan tool package version having the new catalog before the installation of the software update is attempted. This ensures that when the agent first attempts to refresh the inventory locally, it will force the program dependency to run, and this in turn is going to ensure the recent catalog is cached down to the client. The download and execute configuration of the Distribute Software Updates Wizard program's advertisement will be observed automatically for the dependent program since it has no advertisement of its own.

10. Create a new advertisement for the Distribute Software Updates Wizard program, set it for download and execute, and the appropriate collection.
Verify the intended use of Coordinated Universal Time if you intend all activities to take place in unison rather than time zone by time zone. Typically, you would include the Coordinated Universal Time option in the advertisement if you used it on the software update “Authorized on” setting.
Make sure the advertisement start time is before the first mandatory assignment time, this will allow the Advanced Client to download first and be ready to start when the service window arrives. (This is more important when service windows are being used.)
Repeat this as needed for each change window (restricted installation time).

11. Monitor the deployment of the newly created package for status and compliance using the available reports under “Software Update—Deployment Status.”

Investigations typically involve two phases: phase one focuses on software distribution success (advertisement success), and phase two focuses on deployment status.
Software update distribution status by software update ID

This report will give you the count of “Install Verified,” “No Status,” or “Failed,” and provides further information for each category. If the numbers in categories other than “Install Verified” are very high, it will be necessary to run this report for each one of them.
Software update status messages for a specific computer within a specified number of days

This report will provide the reader with the real status of the installation. In cases where this report doesn't explain the reasons why a software update failed to install, you must check the actual computer details for advertisement status.

12. Following the emergency situation (after adequate compliance has been reached), amend the mainline package with the recent software updates for ongoing operations and retire the initial package. This involves copying files from one package source folder into another, then use of the Advanced and then Import buttons in the Distribute Software Updates Wizard. This advertisement would typically be set to run from the network due to its size.

13. Delete the expedited program item you created for the preproduction collection members and the nonexpedited program you created for the production collection members.

As mentioned above, the detailed example above regarding MOF is merely an exemplary description of one embodiment of a patch management process. The invention is not limited to any particular combination of activities, sub-activities, trigger events or other actions described above, nor are any embodiments of the invention limited by details of any other embodiments described herein.

The above-described embodiments of the present invention can be implemented in any of numerous ways. For example, some aspects may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. In particular, each of the top-level activities may include any of a variety of sub-activities. For example, the top-level activities described herein may include one or any combination of sub-activities described herein or may include other sub-activities that refine the hierarchical structure of instructing and administering a patch management process.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method of instructing users in the implementation of a patch management process, the patch management process relating to the installation of a software patch in a computer system, the method comprising an act of:
providing instructions that describe the patch management process in a hierarchical manner so that the patch management process is described as comprising a plurality of top-level activities, with each of the plurality of top-level activities being described as comprising at least one sub-activity, the instructions describing trigger events that result in transitions between the top-level activities.

2. The method of claim 1, wherein each top-level activity is associated with one of the trigger events, and wherein the act of providing instructions comprises an act of providing instructions that describe performing the top-level activities in a predetermined sequence such that a particular top-level activity is performed only after the trigger event associated with a preceding top-level activity in the predetermined sequence has occurred.

3. The method of claim 2, wherein the act of providing instructions comprises an act of providing instructions so that the patch management process is described as comprising a top-level assess activity that includes conducting an inventory of assets of the computer system in preparation for future anticipated but unspecified patches.

4. The method of claim 3, wherein the act of providing instructions comprises an act of providing instructions that describe the trigger event associated with the top-level assess activity as being a receipt of notification that at least one new software update is available.

5. The method of claim 4, wherein the act of providing instructions comprises an act of providing instructions that describe a top-level identify activity that includes determining whether the at least one new software update should be deployed.

6. The method of claim 5, wherein the act of providing instructions comprises an act of providing instructions that describe performing the top-level identify activity after the top-level assess activity in the predetermined sequence.

7. The method of claim 6, wherein the act of providing instructions comprises an act of providing instructions that describe the trigger event associated with the top-level identify activity as being a submission of a request to deploy the at least one new software update.

8. The method of claim 6, wherein the act of providing instructions comprises an act of providing instructions that describe a top-level evaluate and plan activity that includes planning and building a release of the at least one new software update.

9. The method of claim 8, wherein the act of providing instructions comprises an act of providing instructions that describe performing the top-level evaluate and plan activity after the top-level identify activity in the predetermined sequence.

10. The method of claim 9, wherein the act of providing instructions comprises an act of providing instructions that describe the trigger event associated with the top-level evaluate and plan activity as being a receipt of authorization to deploy the at least one new software update.

11. The method of claim 9, wherein the act of providing instructions comprises an act of providing instructions that describe a top-level deploy activity including deploying the software update to the computer system.

12. The method of claim 11, wherein the act of providing instructions comprises an act of providing instructions that describe performing the top-level deploy activity after the top-level evaluate and plan activity in the predetermined sequence.

13. The method of claim 12, wherein the act of providing instructions comprises an act of providing instructions that describe the trigger event associated with the top-level deploy activity as being a completion of an installation of the at least one new software update.

14. A method of implementing a patch management process to install a software patch in a computer system, the method comprising an act of:
following instructions that describe the patch management process in a hierarchical manner so that the patch management process is described as comprising a plurality of top-level activities, with each of the plurality of top-level activities being described as comprising at least one sub-activity, the instructions describing trigger events that result in transitions between the top-level activities.

15. The method of claim 14, wherein each top-level activity is associated with one of the trigger events, and wherein the act of following instructions comprises an act of following instructions that describe performing the top-level activities in a predetermined sequence such that a particular top-level activity is performed only after the trigger event associated with a preceding top-level activity in the predetermined sequence has occurred.

16. The method of claim 15, wherein the act of following instructions comprises an act of following instructions that describe the patch management process as comprising a top-level assess activity that includes conducting an inventory of assets of the computer system in preparation for future anticipated but unspecified patches.

17. The method of claim 16, wherein the act of following instructions comprises an act of following instructions that describe the trigger event associated with the top-level assess activity as being a receipt of notification that at least one new software update is available.

18. The method of claim 17, wherein the act of following instructions comprises an act of following instructions that describe a top-level identify activity that includes determining whether the at least one new software update should be deployed.

19. The method of claim 18, wherein the act of following instructions comprises an act of following instructions that describe performing the top-level identify activity after the top-level assess activity in the predetermined sequence.

20. The method of claim 19, wherein the act of following instructions comprises an act of following instructions that describe the trigger event associated with the top-level identify activity as being a submission of a request to deploy the at least one new software update.

21. The method of claim 19, wherein the act of following instructions comprises an act of following instructions that describe a top-level evaluate and plan activity that includes planning and building a release of the at least one new software update.

22. The method of claim 21, wherein the act of following instructions comprises an act of following instructions that describe performing the top-level evaluate and plan activity after the top-level identify activity in the predetermined sequence.

23. The method of claim 22, wherein the act of following instructions comprises an act of following instructions that describe the trigger event associated with the top-level evaluate and plan activity as being a receipt of authorization to deploy the at least one new software update.

24. The method of claim 22, wherein the act of following instructions comprises an act of following instructions that describe a top-level deploy activity including deploying the software update to the computer system.

25. The method of claim 23, wherein the act of following instructions comprises an act of following instructions that describe performing the top-level deploy activity after the top-level evaluate and plan activity in the predetermined sequence.

26. The method of claim 24, wherein the act of following instructions comprises an act of following instructions that describe the trigger event associated with the top-level deploy activity as a completion of an installation of the at least one new software update.

27. A method of administering a computer system that comprises one or more software packages that are anticipated to receive patches, the patches to be installed on at least one computer device in the computer system, the computer system comprising a plurality of resources that are employed in the installation of the patches, the method comprising an act of:
distinct from the installation of any particular patch, assessing the computer system to determine the preparedness of the computer system to process future anticipated but unspecified patches.

28. The method of claim 27, further comprising an act of, in response to information determined during the act of assessing, taking action that impacts at least one of the plurality of resources to improve the preparedness of the computer system to process future anticipated but unspecified patches.

29. The method claim 27, wherein the act of assessing the computer system comprises an act of compiling a list of computer assets comprising the computer system.

30. The method of claim 27, wherein the act of assessing is performed following each installation of one or more of the patches.

31. The method of claim 30, wherein the method is performed in a hierarchical manner comprising a plurality of top-level activities, each of the plurality of top-level activities comprising at least one sub-activity, the plurality of top-level activities performed in a predetermined sequence, the predetermined sequence performed in an ongoing cycle such that the act of assessing is continuously repeated.

32. A method of instructing users in the implementation of a protocol for administering patch management in a computer system that comprises one or more software packages that are anticipated to receive patches, the patches to be installed on at least one computer device in the computer system, the computer system comprising a plurality of resources that are employed in the installation of the patches, the method comprising acts of:
providing instructions that describe procedures for installing the patches; and
providing instructions that describe the protocol as including an assessment phase that is distinct from the installation of particular patches, wherein the assessment phase relates to assessing the computer system to determine the preparedness of the computer system to process future anticipated but unspecified patches.

33. The method of claim 32, wherein the act of providing instructions that describe the protocol comprises an act of providing instructions that describe, in response to information determined during the assessment phase, taking action that impacts at least one of the plurality of resources to improve the preparedness of the computer system to process future anticipated but unspecified patches.

34. The method claim 32, wherein the act of providing instructions that describe the protocol comprises an act of providing instructions that describe compiling, during the assessment phase, a list of computer assets comprising the computer system.

35. The method of claim 32, wherein the act of providing instructions that describe the protocol comprises an act of providing instructions that describe performing the assessment phase following each installation of one or more of the patches.

36. The method of claim 35, wherein the act of providing instructions that describe the protocol comprises an act of providing instructions such that the protocol is described in a hierarchical manner comprising a plurality of top-level activities, each of the plurality of top-level activities being described as comprising at least one sub-activity, the plurality of top-level activities described as being performed in a predetermined sequence, the predetermined sequence describes as being performed in an ongoing cycle such that the assessment phase is continuously repeated.

37. A method of implementing a protocol for administering patch management in a computer system that comprises one or more software packages that are anticipated to receive patches, the patches to be installed on at least one computer device in the computer system, the computer system comprising a plurality of resources that are employed in the installation of the patches, the method comprising acts of:
following instructions that describe the installation of the patches; and
following instructions that describe the protocol as including an assessment phase that is distinct from the installation of particular patches, wherein the assessment phase relates to assessing the computer system to determine the preparedness of the computer system to process future anticipated but unspecified patches.

38. The method of claim 37, wherein the act of following instructions that describe the protocol comprises an act of following instructions that describe, in response to information determined during the act of assessing, taking action that impacts at least one of the plurality of resources to improve the preparedness of the computer system to process future anticipated but unspecified patches.

39. The method of claim 37, wherein the act of following instructions that describe the protocol comprises an act of following instructions that describe performing the assessment phase following each installation of one or more of the patches.

40. The method of claim 39, wherein the act of following instructions that describe the protocol comprises an act of following instructions that describe the protocol in a hierarchical manner comprising a plurality of top-level activities, each of the plurality of top-level activities being described as comprising at least one sub-activity, the plurality of top-level activities performed in a predetermined sequence, the predetermined sequence performed in an ongoing cycle such that the assessment phase is continuously repeated.
